(19) United States
(12) Patent Application Publication
(10) Pub. No.: US 2024/0356007 A1
(43) Pub. Date: Oct. 24, 2024

(54) METHOD FOR PRODUCING ANION-CONTAINING INORGANIC SOLID MATERIAL, DEVICE FOR PRODUCING ANION-CONTAINING INORGANIC SOLID MATERIAL, AND ANION-CONTAINING INORGANIC SOLID MATERIAL

(71) Applicant: TOHOKU UNIVERSITY, Sendai-shi, Miyagi (JP)

(72) Inventors: Takashi NAKAMURA, Sendai-shi (JP); Koji AMEZAWA, Sendai-shi (JP); Takuya KATSUMATA, Sendai-shi (JP)

(21) Appl. No.: 18/687,514

(22) PCT Filed: Aug. 29, 2022
(86) PCT No.: PCT/JP2022/032399

§ 371 Date: Feb. 28, 2024

(30) Foreign Application Priority Data
Aug. 31, 2021 (WO) PCT/JP2021/031908

(51) Int. Cl. H01M 4/13915; H01M 4/04; H01M 4/505; H01M 4/525; H01M 10/0562

(52) U.S. Cl. CPC H01M 4/13915; H01M 4/0407; H01M 4/043; H01M 4/505; H01M 4/525; H01M 10/0562; H01M 2300/008

(57) ABSTRACT

A method for producing an anion-containing inorganic solid material includes: a laminating step of forming a laminate including an electrode, a solid electrolyte layer, and a doping target layer containing a material to be doped; and a doping step of doping the material to be doped with an anion using the doping target layer as a reaction field by applying a voltage to the laminate to have a potential of the doping target layer to be higher than a potential of the electrode.

### CROSS-REFERENCE TO RELATED APPLICATIONS

This application is the U.S. National Stage entry of International Application No. PCT/W2022/032399, filed on Aug. 29, 2022, which claims priority to PCT/W2021/031908, filed on Aug. 31, 2021, both of which are incorporated herein by reference in their entireties for all purposes.

### TECHNICAL FIELD

The present invention relates to a method for producing an anion-containing inorganic solid material, an apparatus for producing an anion-containing inorganic solid material, and an anion-containing inorganic solid material.

### BACKGROUND ART

In inorganic solid materials including inorganic functional materials such as energy materials, catalysts, and magnetic materials, it has been found that functionality can be exhibited and enhanced by controlling an anion composition, and among them, anion composition control has been recognized as a promising material development guide. However, in techniques such as “reaction with an anion source” and “mechanical milling” in the related art, except for very limited conditions and materials, an amount of an anion to be added is determined depending on reaction conditions (synthesis conditions) at the time of adding the anion.

For example, in the invention of Patent Document 1, there is disclosed a method in which a solid electrolyte and a current collector are placed on a sintered ceramic as an inorganic solid material and a current is caused to pass between the ceramic and the current collector to dope the sintered ceramic with ions. Patent Document 1 discloses that with such an action, it is possible to dope a doping target inorganic solid material with metal cations from the solid electrolyte layer on an anode side and with anions from the solid electrolyte layer on a cathode side.

### Citation List

### Patent Document

Patent Document 1: JP H10-218639 A

### SUMMARY OF INVENTION

### Technical Problem

However, in the method of Patent Document 1, the anion species to be introduced into the layer of the inorganic solid material, which is a doping target, is only oxygen, and there is no disclosure about doping with an anion species other than oxygen. In addition, in Patent Document 1, for facilitating doping with metal ions which are cations, doping with oxygen ions which are anions is merely performed together with the metal ions, and there is no disclosure of introducing an arbitrary amount of oxygen ions. As described above, in the doping method in the related art, it is impossible to introduce an arbitrary amount of anion species, and it is extremely difficult to strategically control the anion composition.

The present invention has been made in view of the circumstances described above, and is directed to providing a method for producing an anion-containing inorganic solid material in which one or more anion species can be introduced into an inorganic solid material in an arbitrary amount, an apparatus for producing an anion-containing inorganic solid material, and an anion-containing inorganic solid material.

### Solution to Problem

(1) A method for producing an anion-containing inorganic solid material according to a first aspect of the present invention includes: a laminating step of forming a laminate including an electrode, a solid electrolyte layer, and a doping target layer containing a material to be doped; and a doping step of doping the material to be doped with an anion using the doping target layer as a reaction field by applying a voltage to the laminate to have a potential of the doping target layer to be higher than a potential of the electrode.
(2) In the method for producing an anion-containing inorganic solid material according to (1) above, in the laminating step, the electrode, the solid electrolyte layer, and the doping target layer may be laminated in this order to be in contact with each other as the laminate.
(3) In the method for producing an anion-containing inorganic solid material according to (1) above, in the laminating step, the electrode, the solid electrolyte layer, a metal mesh, and the doping target layer may be laminated in this order to be in contact with each other as the laminate,
the method may further include a potential adjusting step, and
in the potential adjusting step, a conductive wire may be provided to have a potential of the metal mesh to be equal to a potential of a surface of the doping target layer, the surface layer being opposite to a surface of the doping target layer that is in contact with the metal mesh.
(4) The method for producing an anion-containing inorganic solid material according to any one of (1) to (3) above may further include, before the laminating step, an oxygen vacancy forming step of forming an oxygen vacancy in the material to be doped by heating and cooling an inorganic oxide to be used as the material to be doped in an inert gas atmosphere, and in the doping step, the oxygen vacancy in the material to be doped may be doped with the anion.
(5) In the method for producing an anion-containing inorganic solid material according to any one of (1) to (4) above, in the laminating step, the laminate may be formed by using a halide as the solid electrolyte layer, and in the doping step, a halide ion may be used as the anion for doping.
(6) In the method for producing an anion-containing inorganic solid material according to any one of (1) to (5) above, in the laminating step, the laminate may be formed by using, as the solid electrolyte layer and the electrode, a solid electrolyte layer containing a halide and a reversible electrode containing a halide, respectively, and in the doping step, the material to be doped may be doped with a halide ion in the reversible electrode through the solid electrolyte layer.
(7) In the method for producing an anion-containing inorganic solid material according to any one of (1) to (6) above, in the laminating step, the doping target layer may be formed with a mixture obtained by mixing the material to be doped and a soluble solid electrolyte.
(8) The method for producing an anion-containing inorganic solid material according to any one of (1) to (7) above may include a washing step of washing the mixture to remove the soluble solid electrolyte after the doping step.
(9) In the method for producing an anion-containing inorganic solid material according to any one of (1) to (8) above, the material to be doped may be a metal oxide having any one of a crystal structure selected from a perovskite structure, a layered perovskite structure, a layered rock-salt structure, and a spinel structure.
(10) In the method for producing an anion-containing inorganic solid material according to any one of (1) to (9) above, before the laminating step, an oxygen vacancy forming step of forming an oxygen vacancy in the material to be doped need not be performed, in the laminating step, the laminate may be formed by using, as the material to be doped, a metal oxide having a layered perovskite structure, and after the laminating step, the doping step may he performed.
(11) The method for producing an anion-containing inorganic solid material according to any one of (1) to (10) above may include: a first laminating step of forming a first laminate, the first laminate including a first reversible electrode, a first solid electrolyte layer, and a doping target layer containing the material to be doped, each laminated in this order; a first doping step of doping the material to be doped with a first anion by applying a voltage to the first laminate to have a potential of the doping target layer to be higher than a potential of the first reversible electrode; a second laminating step of forming a second laminate, the second laminate including a second reversible electrode, a second solid electrolyte layer, and a doping target layer containing the material to be doped that has been doped with the first anion, each laminated in this order; and a second doping step of doping the material to be doped with a second anion by applying a voltage to the second laminate to have a potential of the doping target layer to be higher than a potential of the second reversible electrode.
(12) In the method for producing an anion-containing inorganic solid material according to any one of (1) to (11), in the first laminating step, the laminate may he formed by using the first solid electrolyte layer and the first reversible electrode each containing a first halide, in the first doping step, the material to he doped may be doped with a first halide ion in the first reversible electrode through the first solid electrolyte layer, in the second laminating step, the second laminate may be formed by using the second solid electrolyte layer and the second reversible electrode each containing a second halide, and in the second doping step, the material to he doped may be doped with a second halide ion in the second reversible electrode through the second solid electrolyte layer.
(13) In the method for producing an anion-containing inorganic solid material according to any one of (1) to (12) above, in the doping step, a potential difference may be imparted between the doping target layer and the electrode while pressurizing the laminate in a laminating direction.
(14) An apparatus for producing an anion-containing inorganic solid material according to one aspect of the present invention includes: a housing portion including a bottom wall portion and a sidewall portion, the housing portion being conductive and configured to house a laminate including an electrode, a solid electrolyte layer, and a doping target layer containing a material to be doped; a conductive member disposed to face the bottom wall portion of the housing portion, the conductive member configured to press the laminate in a laminating direction of the laminate; and a voltage applying unit configured to apply a voltage between the conductive member and the housing portion to have a potential of the conductive member to be higher than a potential of the housing portion.
(15) In the apparatus for producing an anion-containing inorganic solid material according to (14) above, in the laminate, the electrode, the solid electrolyte layer, and the material to be doped may be laminated in this order to be in contact with each other.
(16) In the apparatus for producing an anion-containing inorganic solid material according to (14) above, in the laminate, the electrode, the solid electrolyte layer, a metal mesh. and the doping target layer may he laminated in this order to be in contact with each other, and the apparatus may further include a conductive wire that connects the metal mesh and a member that is in contact with a surface of the doping target layer opposite to a surface of the doping target layer that is in contact with the metal mesh.
(17) The apparatus for producing an anion-containing inorganic solid material according to any one of (14) to (16) above may further include: a sealed vessel accommodating the housing portion and the conductive member; and a heating unit configured to heat an inside of the sealed vessel.
(18) An anion-containing inorganic solid material according to an aspect of the present invention is represented by the following Formula (1) and has a layered rock-salt structure:

Li₂TMO_{3-δ}Fₓ (1)
where in Formula (1), TM is Ni or Mn, δ satisfies 0.3≤δ≤2, and x is a number satisfying0.3≤x≤2.

### Advantageous Effects of Invention

According to the method for producing an anion-containing inorganic solid material, the apparatus for producing an anion-containing inorganic solid material, and the anion-containing inorganic solid material of the present invention, one or more anion species can be introduced. into the inorganic solid material in an arbitrary amount.

### BRIEF DESCRIPTION OF DRAWINGS

FIG. 1 is a flowchart illustrating an example of a method for producing an anion-containing inorganic solid material according to a present embodiment.

FIG. 2 is a view for explaining a doping step in FIG. 1.

FIG. 3 is a flowchart illustrating a modification of the method for producing an anion-containing inorganic solid material illustrated in FIG. 1.

FIG. 4 is a view for explaining a doping step in FIG. 3.

FIG. 5 is a flowchart illustrating another modification of the method for producing an anion-containing inorganic solid material illustrated in FIG. 1.

FIG. 6 is a flowchart illustrating still another modification of the method for producing an anion-containing inorganic solid material illustrated in FIG. 1,

FIG. 7 is a cross-sectional view illustrating an example of an apparatus for producing an anion-containing inorganic solid material according to a present embodiment.

FIG. 8 is a cross-sectional view illustrating an apparatus for producing an anion-containing inorganic solid material according to a modification of FIG. 7.

FIG. 9 is an SEM-EDX image of an anion-containing inorganic solid material of Example 1.

FIG. 10 is a diagram indicating X-ray diffraction patterns of Example 2 and Production Example 1.

FIG. 11 is a diagram indicating measurement results of Example 2, Production Example 1, and Production Example 2 by X-ray photoelectron spectroscopy.

FIG. 12 is a diagram indicating X-ray diffraction patterns of Example 3, Example 4, Production Example 3, Production Example 4, and a solid electrolyte BaF₂.

FIG. 13 is a view for explaining operations of a laminating step and a doping step in Example 5.

FIG. 14 is a diagram indicating a change with time of a voltage value applied between a doping target layer 1B and a reversible electrode 3 in a second doping step.

FIG. 15 is a diagram indicating X-ray diffraction patterns of Example 5, Example 6, and Example 7.

FIG. 16 is a diagram indicating X-ray diffraction patterns of Example 8, Example 9. and Production Example 5.

FIG. 17 is a diagram indicating a lattice constant estimated from an X-ray diffraction pattern of Example 8.

FIG. 18 is a diagram indicating X-ray diffraction patterns of Example 10, Production Example 6, and Production Example 7.

FIG. 19 indicates XPS measurement results of an anion-containing inorganic solid. material of Example 10 and an inorganic solid material of Production Example 6.

FIG. 20(a) indicates XRD measurement results of Example 11, Example 12, and a material powder to be doped before the doping step, and FIG. 20(b) indicates XPS measurement results of Example 11, Example 12, and a material to be doped before the doping step.

FIGS. 21(a), 21(b), and 21(c) indicate TOF-SIMS spectra of the material to he doped before treatment. Example 11, and Example 12, respectively.

FIG. 22(a) indicates XRD measurement results of Example 13 and the material powder to be doped before the doping step, and FIG. 22(b) indicates XPS measurement results of Example 13 and the material to be doped before the doping step.

FIG. 23(a) indicates XRT) measurement results of Example 14 and the material powder to be doped before the doping step, and FIG. 23(b) indicates XPS measurement results of Example 14, the material to be doped before the doping step, nickel (II) oxide, and lithium nickel (III) dioxide.

FIG. 24 indicates TOE-SIMS spectra of Example 14 and the material to be doped before treatment used in Example 14.

FIG. 25 indicates charge and discharge curves of battery cells of Example 15 and Comparative Example 1.

### DESCRIPTION OF EMBODIMENTS

Hereinafter, embodiments of the present invention will be described with reference to the accompanying drawings. Note that in the drawings used in the following description, to make features of the present invention easy to understand, portions corresponding to the features are sometimes indicated enlarged for the sake of convenience. For this reason, dimensional ratios and the like of components may be different from actual ones.

### Method for Producing Anion-Containing Inorganic Solid Material

A method for producing an anion-containing inorganic solid material according to a present includes: a laminating step of forming a laminate in which a reversible electrode, a solid electrolyte layer, and a doping target layer containing a material to be doped are laminated in this order; and a doping step of doping the material to be doped with an anion using the doping target layer as a reaction field by applying a voltage to the laminate to have a potential of the doping target layer to be higher than a potential of the reversible electrode. Another step may be included before the laminating step, between the laminating step and the doping step, or after the doping step, without departing from the scope of the present invention.

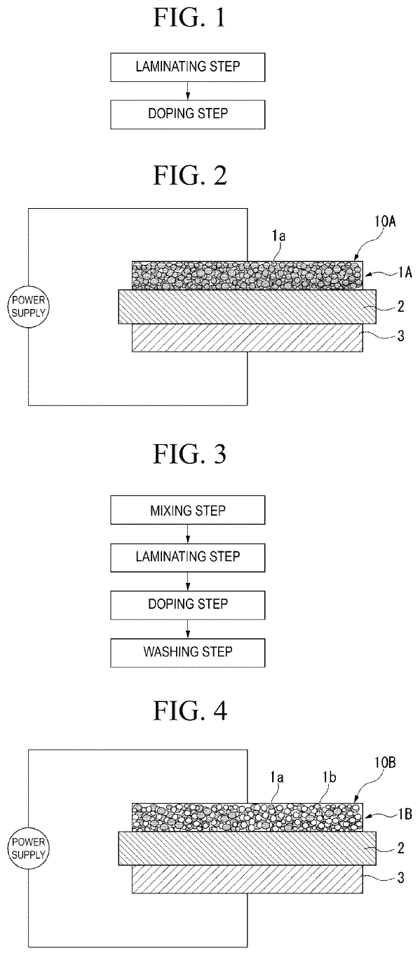

FIG. 1 is a flowchart illustrating an example of the method for producing an anion-containing inorganic solid material according to a present embodiment, and FIG. 2 is a view for explaining the doping step in FIG. 1.

In the method for producing an anion-containing inorganic solid material illustrated in FIG. 1, a metal oxide having a crystal structure of a layered perovskite structure is typically used as a material to be doped, although it is not particularly limited thereto. The metal oxide having a layered perovskite structure (layered perovskite oxide) is represented by a composition formula A₂BO₄ (where the site A is a rare earth ion or an alkaline earth metal ion and the site B is a transition metal ion). Note that in each of the site A and the site B, a plurality of types of ions may be located. The layered perovskite oxide belongs to a homologous phase (AO)ₙ(ABO₃)ₙ (n=1, 2, 3, . . . ) and has a pseudo two-dimensional structure in which an ABO₃ lattice of a perovskite type and an AO layer of a rock-salt type lattice are alternately laminated. The layered. perovskite oxide has an anion site at each of three sites including an in-plane site surrounded by four A ions and two B ions, an apex site surrounded by five A ions and one B ion, and further a vacant interstitial site surrounded by four A ions in the rock-salt structure. The anion site is a site which an anion can enter. As the layered perovskite oxide, for example, (La,Sr)₂MnO₄ such as La_{1.2}Sr_{0.8}MnO₄, (La,Sr)₂FeO₄, (La,Sr)₂CoO₄, (La,Sr)₂NiO₄, (La,Sr)₂CuO₄, (La,Sr)₂RuO₄, (La,Sr)₂IrO₄, (La,Sr)₃Mn₂O₇, or the like can be used. Here, (La,Sr)₂MnO₄ represents LaₓSr₂₋ₓMnO₄ (0<x<2).

The anion species with which the material to be doped is doped is not particularly limited, but is, for example, one or more halide ions, and examples thereof include a fluoride ion and a chloride ion.

### (Laminating Step)

In the laminating step, for example, each of a reversible electrode 3, a solid electrolyte layer 2, and a doping target layer 1A containing a material 1a to be doped is prepared as a. molded body, and these molded bodies are laminated to form a laminate 10A.

Specifically, first, for example, a housing portion which is open at one end and includes a bottom wall portion and a sidewall portion erected from the bottom wall portion is prepared. Next, a metal film is placed on the bottom wall portion of the housing portion, a powder to be a material of the reversible electrode 3 is housed on the metal film, and the powder is pressed by a pressing portion to form the reversible electrode 3 as a green compact. Next, a solid electrolyte pellet obtained by molding a solid electrolyte is placed to overlap the reversible electrode 3, thereby forming the solid electrolyte layer 2. Next, a powder containing the material 1a to be doped is housed in the housing portion to overlap the solid electrolyte layer 2, and is pressed to form the doping target layer 1A as a green compact on the solid electrolyte layer 2. Note that in a present embodiment, the doping target layer 1A made of the material 1a to be doped may be referred to as a pellet cell. Through the present step, the laminate 10A is obtained.

In the laminating step, as the material to be doped of the doping target layer 1A, the above-described layered perovskite oxide such as (La,Sr)₂MnO₄, (La,Sr)₂FeO₄, (La,Sr)₂CoO₄, (La,Sr)₂NiO₄, (La,Sr)₂CuO₄, (La,Sr)₂RuO₄, (La,Sr)₂IrO₄, (La,Sr)₃Mn₂O₇, or the like can be used to form the laminate 10A. Hereinafter, LaₓSr₂₋ₓMnO₄ (0<x<2) may be represented by LSMO₄.

As described above, the layered perovskite oxide has a vacant site which an anion can enter. Thus, in a case where the layered perovskite oxide is used as the material to be doped, an anion can be introduced into a vacant site without performing pretreatment such as an oxygen vacancy forming step to be described below.

When the doping target layer 1A is formed in the laminating step, a pellet cell containing the material to be doped can he used as the doping target layer 1A. The pellet cell preferably, includes a single phase of the layered perovskite oxide. The pellet cell is formed, for example, by pressing the layered perovskite oxide against a solid electrolyte pellet. This makes it possible to increase a yield of the anion-containing inorganic solid material while suppressing contamination of the anion-containing inorganic solid material with a foreign matter.

In the laminating step, a laminate can be formed by using a halide as the solid electrolyte layer 2. As the solid electrolyte, for example, Ba_{0.99}K_{0.01}F_{1.99}, La_{0.9}Ba_{0.1}F_{2.9}, BaF₂, LaF₃, Ce_{0.9}Sr_{0.1}F_{2.9}, PbSnF₄, PbF₂, SrCl₂, BaCl₂ or the like can be used. In the laminating step, the laminate 10A can be formed by using the solid electrolyte layer 2 and the reversible electrode 3 each containing a halide. For example, in a case where the above-described solid electrolyte is used as the solid electrolyte layer 2 containing a halide, a Pb-PbF₂ mixture, a Ph-PhCl₂ mixture, a Ni-NiF₂ mixture, a Ni-NiCl₂ mixture, a Zn-ZnF₂ mixture, a Zn-ZnCl₂ mixture, a Cu-CuF₂ mixture, a Cu-CuCl₂ mixture, or the like can be used as the reversible electrode 3 containing a

The solid electrolyte layer 2 and the reversible electrode 3 preferably have the same halide ion. For example, in a case where a fluoride ion conductor such as Ba_{0.99}K_{0.01}F_{1.99} is used as the solid electrolyte layer 2, it is preferable to use any of the following selected from the group consisting of a Pb-PbF₂ mixture, a Ni-NiF₂ mixture, and a Cu-CuF₂ mixture as the reversible electrode 3.

In the laminating step, when the laminate 10A is formed by using the material to be doped which is made of the metal oxide and using the solid electrolyte layer 2 and the reversible electrode 3 each containing a halide, an oxygen site of the material to be doped is doped with a halide ion in the doping step to be described below. An ionic radius of the halide ion is close to an ionic radius of oxygen, and thus the material to be doped can be doped with the halide ion as an anion without destroying the crystal structure of the inorganic solid material. In addition, in a case where the laminate 10A is formed by using the solid electrolyte layer 2 and the reversible electrode 3 containing the same halide, when the halide ion of the reversible electrode 3 moves to the solid electrolyte layer 2 in the doping step to be described below, a crystal structure of a composition constituting the solid electrolyte layer 2 is less likely to collapse, and ion conductivity in the solid electrolyte layer 2 can be further enhanced.

### (Doping Step)

In the doping step, a voltage is applied to the laminate 10A in such a manner that a potential of the doping target layer 1A is higher than a potential of the reversible electrode 3. At this time, the doping target layer 1A itself becomes a reaction field, and the material 1a to be doped is doped with the halide ion in the reversible electrode 3 through the solid electrolyte layer 2. In a present embodiment, a vacant site in the material 1a to be doped is doped with the anion. For example, in a case of doping the material 1a to be doped including LSMO₄ with a fluoride ion, a vacant site in the composition ISMO₄ is doped with the fluoride ion, and the material to be doped becomes partially LSMO₄F, or LSMO₄F₂.

In the doping step, it is preferable to give a potential difference between the doping target layer 1A and the reversible electrode 3 of the laminate 10A while pressurizing the laminate 10A in a laminating direction. In the doping step, for example, current collectors (conductive members) are provided at both ends of the laminate 10A in the laminating direction, and a potential difference can be given to the doping target layer 1A and the reversible electrode 3 while pressing the laminate with the current collectors. This can enhance adhesion between the reversible electrode 3 and the solid electrolyte layer 2, which can facilitate anion doping. In the doping step, an apparatus having the same principle as that of an electrochemical measurement apparatus for halogen doping (VersaSTAT 4 (available from AMETEK Inc.), SP-200 (available from BioLogic), or SP-300 (available from BioLogic)) can be used. Note that the doping step may be performed by giving a potential difference between the doping target layer 1A and the reversible electrode 3 without placing current collectors (conductive members) on the laminate and pressing (pressurizing and fixing) the laminate with the conductive members (current collectors).

The doping step is performed, for example, under an inert gas atmosphere by housing the laminate 10A in a sealed space. In addition, the doping step is preferably performed in an environment in which the laminate 10A is heated, and is preferably performed, for example, at room temperature to 700° C. When the doping step is performed under such conditions, it is suppressed that the material to be doped is doped with an anion not contained in the solid electrolyte layer 2 and the reversible electrode 3, whereby an anion-containing inorganic solid material having a desired composition can be formed.

In the doping step, the potential difference given to the doping target layer 1A and the reversible electrode 3 can be changed depending on a size of the laminate 10A, and is, for example, 0.1 V or more. This potential difference may be kept constant during the doping step or may be changed within this range. In addition, during the doping step, a voltage may be applied to the laminate 10A in such a manner that a value of a current flowing through a closed circuit including the laminate 10A is constant. The value of the current flowing in the laminating direction of the laminate 10A with respect to a weight (g) of the material 1a to be doped in the laminate 10A is, for example, 1 mA/g or more.

In the method for producing an anion-containing inorganic solid material according to a present embodiment, the reversible electrode 3, the solid electrolyte layer 2, and the doping target layer 1A are laminated in this order, and a voltage is applied to the laminate 10A in such a manner that the potential of the doping target layer 1A is higher than the potential of the reversible electrode 3, whereby it is possible to control a reaction driving force. Specifically, the reaction driving force can be controlled based on the following equation (2) relating to an electrochemical potential.

$${μ}_{i\_WE} = {μ}_{i\_CE} + zFE \qquad ( 2 )$$

(μ_{i_WE}: chemical potential of the doping target layer 1A, μ_{i_CE}: chemical potential of the reversible electrode 3, z: ionic valence, F: Faraday constant, E: potential difference between the doping target layer 1A and the reversible electrode 3)

As indicated in the equation (2), the chemical potential μ_{i_WE} of the doping target layer lA changes depending on the potential difference E between the doping target layer 1A and the reversible electrode 3 and the chemical potential μ_{i_CE} of the reversible electrode 3. That is, in the doping step, an amount of the anion with which the material 1a to be doped is doped can be controlled by the potential difference E between the doping target layer 1A and the reversible electrode 3 and/or the chemical potential μ_{i_CE} of the reversible electrode 3. In the equation (2), when a type of the reversible electrode 3 is changed in a state where the potential difference F between the doping target layer 1A and the reversible electrode 3 is fixed, the chemical potential μ_{i_CE} of the reversible electrode 3 changes, and thus the chemical potential μ_{i_WE} of of the material 1a to be doped also changes. When the potential difference E between the doping target layer 1A and the reversible electrode 3 is changed, the chemical potential μ_{i_WE} of the doping target layer 1A is changed without changing the chemical potential μ_{i_CE} of the reversible electrode 3. In a present embodiment, it is possible to control the amount of the anion which is used for doping in the doping step by changing the chemical potential μ_{i_WE} of the doping target layer 1A as described above.

In addition, in the method for producing an anion-containing inorganic solid material according to a present embodiment, a voltage is applied between the doping target layer 1A and the reversible electrode 3, which makes it possible to apply a high pressure to the anion in the reversible electrode 3, whereby doping can proceed. For example, when the reversible electrode 3 including a Pb-PbF₂ mixture is used and a voltage of 3.2 V is applied between the doping target layer 1A and the reversible electrode 3, it is possible to apply a pressure corresponding to 3000 atm to the fluoride ion in the reversible electrode 3.

Through the laminating step and the doping step, the anion-containing inorganic solid material can be produced.

The specific example of the method for producing an anion-containing inorganic solid material according to a first embodiment has been described above in detail. The present invention is not limited to this example, and may be modified within the scope of the gist of the present invention set forth in the appended claims. For example, a step may be added or changed such that the doping step is divided into two steps. Specifically, the following modifications may be employed. Although FIG. 2 illustrates the laminate 10A in which the doping target layer 1A is provided on the upper side, the reversible electrode 3 may be provided on the upper side as long as the reversible electrode 3, the solid electrolyte layer 2, and the doping target layer 1A are laminated in this order in the laminate 10A.

### (Variation 1)

FIG. 3 is a flowchart illustrating a modification of the method for producing an anion-containing inorganic solid material illustrated in FIG. 1, and FIG. 4 is a view for explaining a doping step in FIG. 3. The method for producing an anion-containing inorganic solid material illustrated in the flowchart of FIG. 3 typically uses a layered perovskite oxide as the material to be doped, Hereinafter, a case where a layered perovskite oxide is used as the material to be doped will be described as an example.

A method for producing an anion-containing inorganic solid material according to Variation 1 is different from the method for producing an anion-containing inorganic solid material according to the above embodiment in that a doping target layer 1B including the material 1a to be doped and a solid electrolyte 1b is used. In addition, the method for producing an anion-containing inorganic solid material according to Variation 1 is different from the method for producing an anion-containing inorganic solid material according to the above embodiment in that in using the doping target layer 1B, a mixing step and a washing step are included. Description of the same steps as those in the method for producing an anion-containing inorganic solid material according to the above embodiment will be omitted.

The method for producing an anion-containing inorganic solid material according to Variation 1 includes, for example, a mixing step, a laminating step, a doping step, and a washing step.

### (Mixing Step)

The mixing step is a step of mixing the material 1a to be doped and the solid electrolyte lb to form a mixture constituting the doping target layer 1B. As the material 1a to be doped, the same material as the material 1a to be doped according to the above embodiment can be used. As the solid electrolyte 1b, a soluble solid electrolyte that can be removed by washing with a washing solution in the washing step to be described below can be used. The solid electrolyte 1b can be appropriately selected depending on the type of the washing solution. In a case where water is used as the washing solution, BaF₂, Ba_{0.99}K_{0.1}F_{1.99}, Sr_{0.99}K_{0.01}Cl_{1.99}, Ce_{0.9}Sr_{0.1}F_{2.9}, PbSnF₄, PbF₂, SrCl₂, BaCl₂ or the like can be used. In a case where pure water is used as the washing solution. BaF₂, Ba_{0.99}K_{0.1}F_{1.99}, SrCl₂, BaCl₂, Ce_{0.9}Sr_{0.1}F_{2.9}, PbSnF₄, PbF₂, SrCl₂, BaCl₂ can be used as the solid electrolyte 1b. The mixing step is performed by utilizing, for example, a known mixer, a ball mill, a pestle, and a mortar.

### (Laminating Step)

In the method for producing an anion-containing inorganic solid material according to Variation 1, in the laminating step after the mixing step, the doping target layer 1B is formed of a mixture obtained by mixing the material 1a to be doped and the solid electrolyte 1b. Specifically, first, the reversible electrode 3 as a green compact and the solid electrolyte layer 2 as a molded body are formed using the same housing portion as in the method for producing an anion-containing inorganic solid material according to the above embodiment. As the solid electrolyte layer 2, it is possible to use a soluble solid electrolyte which can be removed in the washing step to be described below, and for example, the same soluble solid electrolyte as the solid electrolyte lb can be used.

Next, the mixture is introduced onto the solid electrolyte layer 2 in the housing portion and pressed to form the doping target layer 1B including the material 1a to be doped and the solid electrolyte 1b. In a present embodiment, the doping target layer 1B including the material 1a to be doped and the solid electrolyte 1b may be referred to as a composite cell. Next, the housing portion may be filled with a resin and a protective portion may be formed on the radially outer side of the doping target layer 1B. This can suppress deformation of the doping target layer 1B due to lateral dispersion of pressure during pressurization. In addition, insulation between current collectors can be ensured. As the protective portion, any material can be used as long as it has an insulating property. For example, a ceramic ring or a resin can be used, and it is preferable to use a material also having heat resistance such as a ceramic ring,

Next, the solid electrolyte layer 2 and the reversible electrode 3 are laminated on the doping target layer 1B to form a laminate 10B in the same manner as in the method for producing an anion-containing inorganic solid material according to the above embodiment.

### (Doping Step)

The doping step is performed after the laminating step. In the doping step, the material 1a to be doped included in the doping target layer 1B is doped with an anion by the same method as the method for producing an anion-containing inorganic solid material according to the above embodiment.

### (Washing Step)

After the doping step, the washing step is performed on the doping target layer 1B. In the washing step, the mixture of the material 1a. to be doped and the solid electrolyte 1b is washed to remove the solid electrolyte 1b from the mixture. In this washing step, the doping target layer 1B may be taken out and only the solid electrolyte 1b may be removed, or in a case where the solid electrolyte layer 2 includes the solid electrolyte 1b and a soluble solid electrolyte, the laminate 10B may be washed to remove the solid electrolyte layer 2 together with the solid electrolyte 1b. As a washing method, for example, the laminate 10B is immersed in a washing solution to obtain the material 1a to be doped independent from the solid electrolyte 1b and the solid electrolyte layer 2. The washing solution is selected depending on a type of the solid electrolyte 1b. As the washing solution, for example, water or pure water can he used.

In the method for producing an anion-containing inorganic solid material according to Variation 1, the laminate 10B including the doping target layer (composite cell) 1B composed of the material 1a to be doped and the solid electrolyte 1b is formed in the mixing step and the laminating step, and after the doping step, the laminate 103 is washed to remove the solid electrolyte 1b in the washing step, whereby it is possible to independently take out an anion-containing inorganic solid material in which the material 1a to be doped is doped with an anion.

In the method for producing an anion-containing inorganic solid material according to Variation 1, the material 1a to be doped and the solid electrolyte 1b are mixed in the mixing step and then the laminating step is performed. Thus, the solid electrolyte 1b is dispersed in the entire doping target layer 1B, and an area of contact between the material 1a to be doped and the solid electrolyte 1b can be increased, In the doping step, the material 1a to be doped is doped with an anion through a portion where the material 1a to he doped is in contact with the solid electrolyte 1b. Thus, anion doping can be uniformly performed regardless of a relative position of the material 1a to be doped in the doping target layer 1B by increasing the contact portion between the material to he doped and the solid electrolyte, that is, by increasing an ion conduction path.

As a result, even when a defect occurs in particles of the material 1a to be doped, a diffusion distance of the defect can he shortened regardless of the relative position of the material 1a to he doped in the doping target layer 1B. In addition, in Variation 1, the solid electrolyte 1b is located not only at the interface between the doping target layer 1B and the solid electrolyte layer 2 in the laminating direction but also inside the doping target layer 1B, and thus, an anion is easily transferred to the particles of the material 1a to be doped, and a bulk material composed of the anion-containing inorganic solid material is easily formed.

Note that in the washing step of Variation 1, after the doping target layer 1B is taken out from the laminate 10B with tweezers or the like, the doping target layer 1B may be immersed in the washing solution to remove the solid electrolyte 1b. In the washing step, the solid electrolyte lb and the solid electrolyte of the solid electrolyte layer 2 may be removed by applying or spraying the washing solution to the laminate 10B.

### (Variation 2)

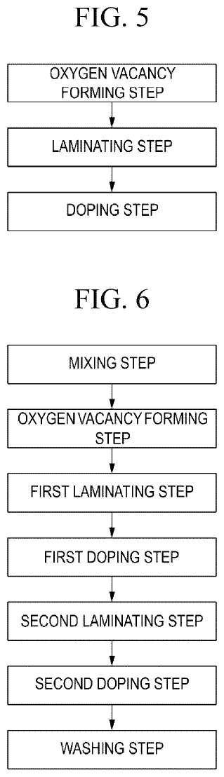

FIG. 5 is a flowchart illustrating another modification of the method for producing an anion-containing inorganic solid material illustrated in FIG. 1. In the method for producing an anion-containing inorganic solid material illustrated in FIG. 5, typically, a metal oxide having any of a crystal structure selected from a perovskite structure, a layered rock-salt structure, and a spinel structure is used as the material to be doped. In the method for producing an anion-containing inorganic solid material of Variation 2, a metal oxide having a layered perovskite crystal structure may be used as the material to be doped. Hereinafter, a case where an oxide (perovskite oxide) having a perovskite crystal structure represented by a composition formula ABO₃ (in the composition formula, A and B are metal elements, and each may be composed of a plurality of metal elements) is used as the material to be doped will he described as an example.

The method for producing an anion-containing inorganic solid material according to Variation 2 is different from the method for producing an anion-containing inorganic solid material according to the first embodiment in that an oxygen vacancy forming step is further included before the laminating step, The method for producing an anion-containing inorganic solid material according to Variation 2 includes, for example, the oxygen vacancy forming step, the laminating step, and the doping step. In the method for producing an anion-containing inorganic solid material according to Variation 2, a case where a pellet cell is laminated as the doping target layer will be described as an example. However, the present invention is not limited thereto, and any of a pellet cell and a composite cell may be laminated as the doping target layer.

### (Oxygen Vacancy Forming Step)

The method for producing an anion-containing inorganic solid material according to Variation 2 includes, before the laminating step, the oxygen vacancy forming step of forming an oxygen vacancy in the material to be doped by heating and cooling an inorganic oxide used as the material to be doped under an inert gas atmosphere. In the oxygen vacancy forming step, for example, the inorganic oxide as the material to be doped is introduced into a sealed space, and heated and cooled in an inert gas atmosphere such as argon. The temperature at which the inorganic oxide is heated is, for example, 200 to 1200° C., and the time for which the inorganic oxide is heated is, for example, 10 hours or longer. After heating, the inorganic oxide is cooled, for example, to room temperature.

When the oxygen vacancy forming step is performed, it is possible to form an oxygen vacancy in the inorganic solid material as the material to be doped. In a case where a perovskite oxide is used as the material to be doped, the composition of the material to be doped becomes ABO₃₋ₓ (x: a number less than 3) after the oxygen vacancy forming step.

After the oxygen vacancy forming step is performed, the laminating step and the doping step are performed in the same manner as in the above embodiment. In the laminating step, the laminate 10A is formed by using a metal oxide having a layered perovskite structure as the material 1a to be doped. In the method for producing an anion-containing inorganic solid material according to Variation 2, in the doping step, the oxygen vacancy of the material to be doped is doped with an anion. In a case where a perovskite oxide is used as the material to he doped and sufficiently doped with an anion represented by Z⁻, the composition of the material to be doped becomes ABO₃₋ₓZ_{d}, and 0<x<3 and 0<d<x are satisfied.

In a case where an oxygen vacancy is formed by using an oxide as the material to be doped and the oxygen vacancy is doped with an anion as in Variation 2, from the viewpoint of obtaining an anion-containing inorganic solid material having a small strain in the crystal structure of the material to be doped by doping, the anion to be used for doping is preferably a fluoride ion or a chloride ion having an ionic radius close to that of an oxygen ion, and more preferably a fluoride ion.

The method for producing an anion-containing inorganic solid material according to Variation 2 further includes the oxygen vacancy forming step, and thus, an inorganic solid material having no vacant site in a standard state can be doped with an anion. In Variation 2, the oxygen vacancy of the material to be doped is doped with an anion, and thus, the upper limit of the amount of the doped anion is the amount of the oxygen vacancy provided in the material to he doped.

In Variation 2, in a case where the layered perovskite oxide is used as the material to be doped, the layered perovskite oxide has a vacant site in the standard state, and thus, it is presumed that the vacant site of the parent phase is first doped with an anion, and then the oxygen vacancy introduced in the oxygen vacancy forming step is doped with the anion.

Further, for example, in the method for producing an anion-containing inorganic solid material according to Variation 2, a composite cell including the material to be doped and a soluble solid electrolyte may be used as the doping target layer, In a case where the composite cell is used as the doping target layer, the mixing step is provided between the oxygen vacancy forming step and the laminating step, and the washing step is provided after the doping step. The mixing step and the washing step can be performed by the same manner as the mixing step and the washing step in the method for producing an anion-containing inorganic solid material according to Variation 1.

### (Variation 3)

FIG. 6 is a flowchart illustrating still another modification of the method for producing an anion-containing inorganic solid material illustrated in FIG. 1, A method for producing an anion-containing inorganic solid material according to Variation 3 is different from the method for producing an anion-containing inorganic solid material according to Variation 1 in that the laminating step and the doping step are each performed twice. In the method for producing an anion-containing inorganic solid material according to Variation 3, the material to be doped is doped with two types of anions. In the method for producing an anion-containing inorganic solid material according to Variation 3, typically, a metal oxide having any of a crystal structure selected from a perovskite structure, a layered rock-salt structure, and a spinel structure is used as the material to be doped. Hereinafter, a case where a perovskite oxide is used as the material to be doped will be described as an example.

The method for producing an anion-containing inorganic solid material according to Variation 3 includes, for example, a mixing step, an oxygen vacancy forming step, a first laminating step, a first doping step, a second laminating step, a second doping step, and a washing step. The mixing step and the oxygen vacancy forming step are the same steps as the mixing step and the oxygen vacancy forming step according to Variation 1. When the oxygen vacancy forming step is performed, the material to be doped becomes a composition represented by a composition formula ABO₃₋ₓ.

After performing the oxygen vacancy forming step, the first laminating step is performed. The first laminating step forms a laminate in which a first reversible electrode, a first solid electrolyte layer, and a doping target layer containing a material to be doped are laminated in this order. The first laminating step can be performed by the same manner as the laminating step according to the above embodiment. In the first laminating step, for example, a first laminate is formed using the first solid electrolyte layer and the first reversible electrode each containing a halide.

After performing the first laminating step, the first doping step is performed. In the first doping step, a voltage is applied to the first laminate in such a manner that a potential of the doping target layer is higher than a potential of the first reversible electrode, and the material to be doped is doped with a first anion. In a case where the first laminate is formed using the first solid electrolyte layer and the first reversible electrode each containing a halide in the first laminating step, the material to be doped is doped with a first halide ion in the first reversible electrode through the first solid electrolyte layer in the first doping step.

In a case where a fluoride ion is introduced as the first halide ion, the material to be doped becomes a composition represented by a composition formula ABO₃₋ₓF_{y} (0<x<3, 0<y≤x).

After the first doping step is performed, the first reversible electrode and the first solid electrolyte layer are removed from the first laminate, and the second laminatimz step is performed. The second laminating step forms a second laminate in which a second reversible electrode, a second solid electrolyte layer, and a doping target layer including a material to be doped which has been doped with the first anion are laminated in this order. In the second laminating step, for example, the second laminate is formed using the second solid electrolyte layer and the second reversible electrode each containing a second halide. The second solid electrolyte layer and the second reversible electrode include, for example, compositions different from those of the first solid electrolyte layer and the first reversible electrode, respectively, and have different anions.

After performing the second laminating step, the second doping step is performed. in the second doping step, a voltage is applied to the second laminate in such a manner that a potential of the doping target layer is higher than a potential of the second reversible electrode, and the material to he doped is doped with a second anion. In a case where the second laminate is formed. using the second solid electrolyte layer and the second reversible electrode each containing a halide ion in the second laminating step, the material to be doped is doped with a second halide ion in the second reversible electrode through the second solid electrolyte in the second doping step.

In a case where a fluoride ion is used for doping as the first anion in the first doping step and a chloride ion different from the first anion is used for doping as the second anion in the second doping step, the material to be doped becomes a composition represented by a composition formula ABO₃₋ₓF_{y}Cl_{z} (0<x<3, 0<y+z≤x).

After the second doping step is performed, the washing step may be performed. The washing step can be performed, for example, by the same method as the washing step in Variation

In the method for producing an anion-containing inorganic solid material according to Variation 3, an anion-containing inorganic solid material doped with a plurality of anion species in arbitrary amounts can be produced through the first laminating step, the first doping step, the second laminating step, and the second doping step.

In the above example, to dope the material to be doped with two types of anions, the laminating step and the doping step are performed twice. However, the material to be doped may be doped with three or more types of anions. In a case where the material to be doped is doped with three or more types of anions, the same number of laminating steps and doping steps as the number of anion species to be used for doping can be provided between the oxygen vacancy forming step and the washing step. For the solid electrolyte layer and the reversible electrode formed in each laminating step, compounds containing different types of anions are used.

In addition, in the present modification, the case where the second anion different from the first anion is used for doping has been described as an example, but the present invention is not limited thereto, and the first anion used in the first doping step may be used for doping as the second anion in the second doping step. In this case, the material to be doped after the second doping step becomes, for example, a composition represented by a composition formula ABO₃₋ₓF_{y′} (0<x<3, 0<y′≤x, y<y′), and the material to be doped after the first doping step can be further doped with a fluoride ion.

Alternatively, a metal electrode may be used instead of the reversible electrode 3. As the metal electrode, for example, a noble metal such as Pt or Au or a base metal such as Fe or Ni can be used, and a noble metal such as Pt or Au is preferable. In a case where a metal electrode is used instead of the reversible electrode 3, the solid electrolyte is electrolyzed to serve as a halogen source, and one or more anions can be introduced into the material to be doped in an arbitrary amount. The laminating step and the doping step may be performed using the same apparatus or different apparatuses,

### Apparatus for Producing Anion-Containing Inorganic Solid Material

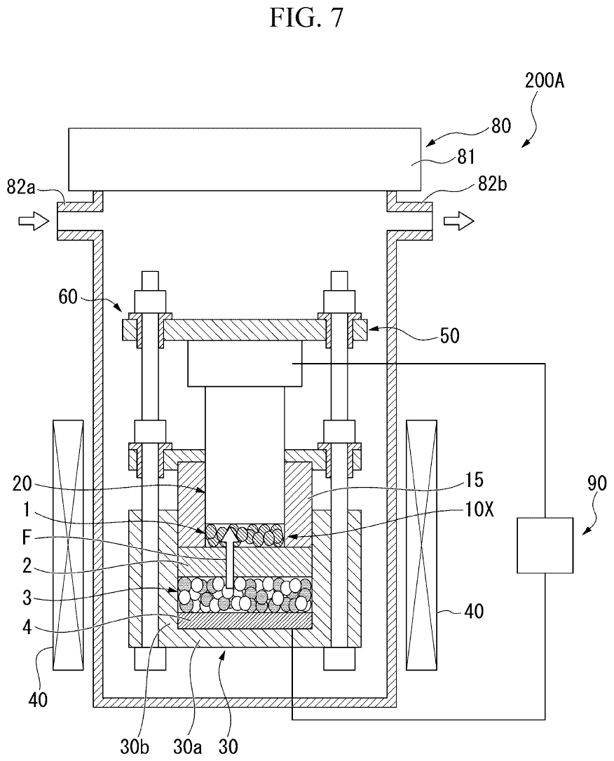

FIG. 7 is a cross-sectional view illustrating an example of an apparatus for producing an anion-containing inorganic solid material according to an embodiment of the present invention, An apparatus 200A for producing an anion-containing inorganic solid material illustrated in FIG. 7 includes: a conductive housing portion 30 including a bottom wall portion 30a and a sidewall portion 30b, the housing portion 30 being capable of housing a laminate lox including a reversible electrode 3, a solid electrolyte layer 2, and a doping target layer 1 containing a. material to be doped; a pressing portion 20 disposed to face the bottom wall portion 30a of the housing portion 30, the pressing portion 20 being a conductive member capable of pressing the laminate 10 in a laminating direction of the laminate and a voltage applying unit 90 configured to apply a voltage between the pressing portion 20 and the housing portion 30 in such a manner that a potential of the pressing portion 20 is higher than a potential of the housing portion 30. In the production apparatus 200A, the laminate 10X is firmed by laminating the reversible electrode 3, the solid electrolyte layer 2, and the material 1 to be doped in this order to be in contact with each other. Materials of the respective layers constituting the laminate 10X may be the same as those of the laminate 10A or the laminate 10B. In addition, in the housing portion 30, the sidewall portion 30b is, for example, a member erected from the bottom wall portion 30a.

The production apparatus 200A further includes, for example, a metal plate 4 disposed between the bottom wall portion 30a of the housing portion 30 and the reversible electrode 3 serving as an ion source and connected to the voltage applying unit 90. The metal plate 4 is made of a material having high conductivity such as a metal, and is made of, for example, the same element as a doping element for doping the material to be doped. The metal plate 4 may be omitted. The pressing portion 20 and the housing portion 30 are held by, for example, an assembly member 50. The assembly member 50 is a framework that defines structures such as the pressing portion 20 and the housing portion 30.

The production apparatus 200A further includes, for example, a sealed vessel 80 that houses the pressing portion 20 and the housing portion 30, and a heating unit 40 that heats the inside of the sealed vessel 80, As the heating unit 40, a known heater can be used. In the production apparatus 200A, a pressing device 60 is housed in, for example, the sealed vessel 80 provided with a cover 81.

The production apparatus 200A further includes, for example, an insulating protective portion 15 in a region radially inward of the sidewall portion 30b and radially outward of the pressing portion 20. The protective portion 15 is, for example, a tubular member including a hole penetrating in a predetermined direction, and has a ring shape when viewed in the axial direction. The protective portion 15 serves to prevent the conductive pressing portion 20 and the housing portion 30 from coming into contact with each other. The protective portion 15 is made of, for example, an insulating member,

The pressing device 60 includes the housing portion 30 that is capable of housing the laminate 10 therein and includes an opening having an inner diameter larger than the diameter of the pressing portion 20 at one end, the pressing portion 20, and the assembly member 50.

The production apparatus 200A of a present embodiment further includes, for example, a gas introduction portion 82a through which an inert gas is introduced into the sealed vessel 80 and a gas discharge portion 82h through which a gas in the sealed vessel 80 is discharged to reduce the pressure in the sealed vessel 80. The gas discharge portion 82b is, for example, a member connected to known exhaust means, and is connected to an exhaust pump.

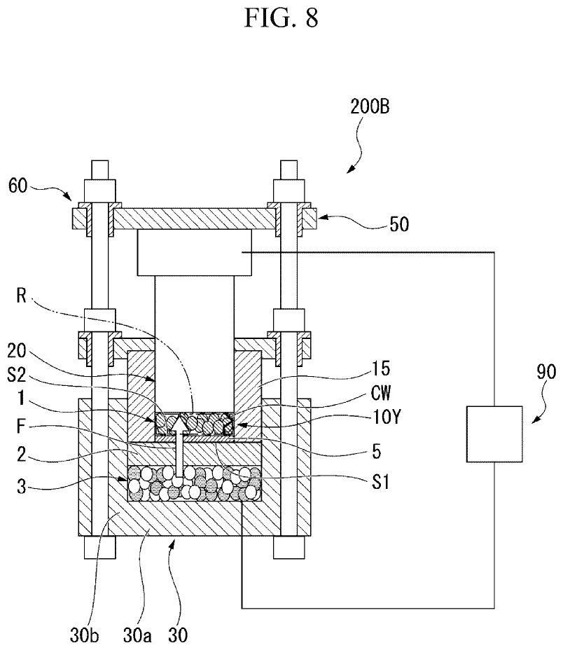

FIG. 8 is a cross-sectional view illustrating an example of an apparatus for producing an anion-containing inorganic solid material according to a modification of FIG. 7. In FIG. 8, the same components as those in FIG. 7 are denoted by the same reference numerals, and description thereof will be omitted. In FIG. 8, the sealed vessel 80 and the heating unit 40 are not illustrated. In an apparatus 200B for producing an anion-containing inorganic solid material illustrated in FIG. 8, a laminate 10Y is formed by laminating a reversible electrode 3, a solid electrolyte layer 2, a metal mesh 5, and a doping target layer 1 in this order to be in contact with each other, and further includes a conductive wire CW for connecting the metal mesh 5 and a member (pressing portion 20) in contact with a surface S2 of the doping target layer 1 opposite to a surface Si in contact with the metal mesh 5. The conductive wire CW is made of, for example, a conductive material.

The metal mesh 5 contains, for example, a noble metal as a main component. An noble metal may be used as long as it does not react with fluorine, and for example, platinum, gold, silver, or ruthenium can be used. For example, the metal mesh 5 is disposed in the protective portion 15 in an in-plane direction. The metal mesh 5 serves, for example, to separate the material 1 to be doped and the solid electrolyte contained in the solid electrolyte layer 2 from each other. As long as the metal mesh 5 is configured to be able to separate the material 1 to be doped and the solid electrolyte from each other, physical configuration of the metal mesh 5 such as a mesh opening, an aperture ratio, and a thickness can be arbitrarily set. As the metal mesh 5, at least one sheet of metal mesh can be used, and a plurality of sheets of metal mesh such as two or more sheets may be stacked. The doping target layer 1 is located, for example, in a region R surrounded by the pressing portion 20, the protective portion 15, and the metal mesh 5. Here, in the production apparatus 200B, the protective portion 15 serves to prevent a gas in the region R from escaping to the outside in the in-plane direction with respect to the doping target layer 1.

The metal mesh 5 is connected to the pressing portion 20 by the conductive wire CW, and thus, the metal mesh 5 has the same potential as the pressing portion 20. When a voltage between the metal mesh 5 and the housing portion 30 is controlled, a temperature in a space surrounded by the housing portion 30, the protective portion 15, and the metal mesh 5 becomes high, and a doping gas is generated. The doping gas is, for example, a gas containing an anion in the solid electrolyte layer 2 and the reversible electrode 3 as a main component. An amount of the doping gas can be adjusted by controlling the potential of the metal mesh 5. The doping gas is introduced through holes of the metal mesh 5 into the region R where the doping target layer I is located. With the doping gas introduced into the region R, the material to be doped in the doping target layer 1 is doped. The method for producing an anion-containing inorganic solid material using the production apparatus 200B is vapor phase growth, and thus, it is possible to dope even a material to be doped which is located in the region R and away from the solid electrolyte layer 2 with an anion at a high concentration. In the production method using the production apparatus 200B, the material to be doped in the doping target layer 1 can be doped with an anion without the oxygen vacancy forming step.

In a case where an anion-containing inorganic solid material is produced using the production apparatus 200B, a layered perovskite oxide may be used as the material to be doped, or a metal oxide having any of a crystal structure selected from the group consisting of a perovskite structure, a layered rock-salt structure, and a spinel structure may be used. In a case of using the production apparatus 200B, the oxygen vacancy forming step can be omitted in a case where any of the above materials to be doped is used. In addition, doping is performed by vapor phase growth, and thus, even in a case where the doping target layer including the material to be doped is used without performing the mixing step, the material to be doped at any position in the region R can be doped at a high concentration. For example, in a case where a layered perovskite oxide or a metal oxide having a crystal structure of either a perovskite structure or a spinet structure is used as the material to be doped, it can be doped with an anion other than oxygen. In a case where a layered perovskite oxide or a metal oxide having a crystal structure selected from a perovskite structure and a spinel structure is used as the material to be doped, it can be doped with an anion other than oxygen in a form of addition.

For example, according to the method for producing an anion-containing inorganic solid material using the production apparatus 200B, in a case where an inorganic solid material having a layered rock-salt structure and represented by the general formula Li₂TMO₃ . . . (2) is used as the material to be doped, a part of O element in Formula (2) can be substituted with another anion While the layered rock-salt structure is maintained. In Formula (2), TM is a transition metal of either Ni or Mn. The anion-containing inorganic solid material after substitution is represented by the general formula Li₂TMO_{3-δ}Fₓ . . . (1). In Formula (1), for example, δ≤3 and x≤2 are satisfied, preferably 0.2≤δ and 0.2≤x are satisfied, or 0.3≤δ≤3 and 0.3≤x≤2 are satisfied, or 0.4≤δ≤3 and 0.4≤x≤3 can be satisfied.

In the related art, as the anion-containing inorganic solid material having a layered rock-salt structure and represented by Formula (1), only one having a high fluorine-doping amount of less than 0.2 has been known. However, when O/F exchange is performed in the doping target layer I through a vapor phase using the production apparatus 200B of the above aspect, it is possible to produce an anion-containing inorganic solid material having a high fluorine-doping concentration while maintaining a layered rock-salt structure. In the anion-containing inorganic solid material according to a present embodiment, the layered rock-salt structure is maintained and fluorination is performed, and thus, in a case where the material is used as an electrode layer for a battery, it is possible to provide a material having a high energy density and capable of high-speed Li ion conduction.

Hereinafter, examples of the present invention will be described. The presentinvention_ is not limited to the examples described below.

### EXAMPLES

### Example 1

First, a metal oxide La_{0.6}Sr_{0.4}CoO₃ having a perovskite crystal structure was prepared as a. material to be doped. In the oxygen vacancy forming step, the metal oxide was annealed and cooled to form a composition represented by La_{0.6}Sr_{0.4}ACoO_{2.85}, thereby forming an oxygen vacancy. The annealing of the metal oxide was performed by placing the metal oxide in a sealed furnace body and heating the metal oxide at 800° C. for 24 hours in an argon gas-diluted 1% O2 gas atmosphere. The metal oxide was then quenthed at a cooling rate of at least 500° C./hr to fix an oxygen composition.

Next, the production apparatus 200A illustrated in FIG. 7 was reproduced to perform the laminating step.

In Example 1, as the production apparatus 200A, an apparatus utilizing TB-SOFT (available from NPa SYSTEM CO., LTD.) as a pressing machine was prepared and used.

In Example 1, the gas discharge portion 82b was connected to an exhaust pump.

In the laminating step in Example 1, first, a lead substrate having a diameter of 14.5 mm and a thickness of 0.2 mm was prepared as a current collector, and the metal plate 4 as the lead substrate corresponding to the shape of the housing portion 30 was placed on the bottom wall portion 30a of the housing portion 30. Next, a mixed powder in which a volumetric percentage ratio of lead fluoride was 40 to 50% was prepared, and about 0.5 g of the mixed powder of lead. and lead fluoride was placed on the metal plate 4. Then, the mixed powder was pressed at 60 MPa by the pressing portion 20 having a shape corresponding to the shape of the housing portion 30 to form the reversible electrode 3 having a diameter of 14.5 mm and a thickness of 0.5 mm.

Next, a solid electrolyte pellet of La_{0.9}Ba_{0.1}Fe_{2.9} of about 0.2 g having a diameter of 14.5 mm and a thickness of 2.5 mm was prepared as the solid electrolyte and placed on the reversible electrode 3 to form the solid electrolyte layer 2. Next, an insulating ring was disposed as the protective portion 15 on the solid electrolyte layer 2, and an inorganic oxide La_{0.6}Sr_{0.4}CoO_{2.85} in which an oxygen vacancy was formed in the oxygen vacancy forming step was dispersed on the radially inner side of the insulating ring, followed by pressing by the pressing portion 20.

In this way, a pellet cell including the inorganic oxide La_{0.6}Sr_{0.4}CoO_{2.85} was formed on the solid electrolyte layer 2 as the doping target layer 1 having a diameter of 10 mm and a thickness of 1 mm, whereby the laminate 10 in which the reversible electrode 3, the solid electrolyte layer 2, and the doping target layer 1 were laminated in this order was formed.

Next, the pressing portion 20 as a conductive member was disposed on the laminate 10, and the laminate 10 and the metal plate 4 as the lead substrate were pressed and fixed by a bolt and a nut in a state of being housed in the housing portion 30 of the pressing device 60. In this state, one end of the sealed vessel 80 was closed with the cover 81, the gas in the sealed vessel 80 was discharged through the gas discharge portion 82b, and the sealed vessel 80 was filled with argon gas through the gas introduction portion 82a. Next, the voltage applying unit 90 applied a voltage between the pressing portion 20 and the housing portion 30 in such a manner that a potential of the pressing portion 20 is higher than a potential of the housing portion 30. thereby performing the doping step. In the doping step, the pressure in the sealed vessel 80 was set to about 1×10⁴ Pa, the laminate 10 was heated to 250° C. by the heating unit 40, and a voltage was applied in such a manner that a potential difference between the reversible electrode 3 and the doping target layer 1 was 3 V.

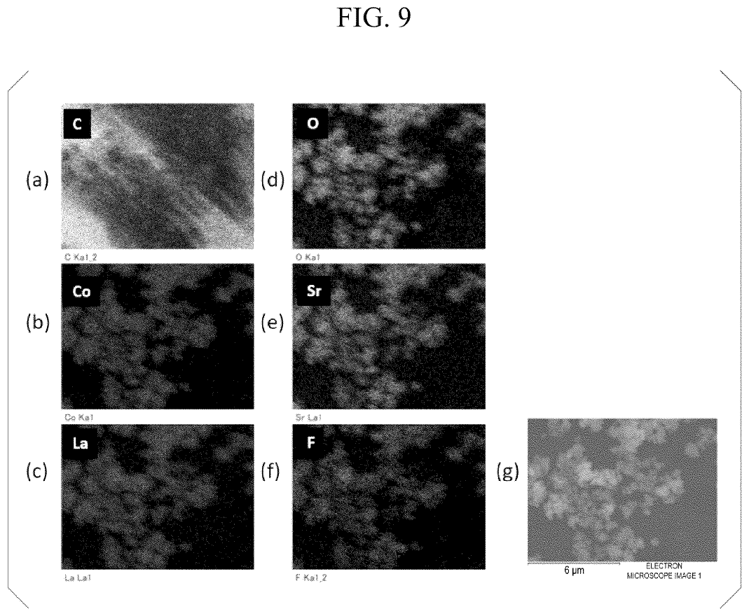

Next, the doping target layer 1 of the laminate 10 of Example 1 was subjected to energy dispersive X-ray spectrometry (SEM-EDX) using a scanning electron microscope (available from JEOL Ltd., model number: JSM-7001F). An accelerating voltage in the SEM-EDX was 30 kV. FIG. 9 is a SEM-EDX image of the doping target layer I. FIGS. 9(a), 9(b). 9(c), 9 (d), 9 (e) and 9(f) are SEM-EDX images obtained by performing SEM-EDX analysis on a SEM image indicated in FIG. 9 (g), and are images obtained by color-mapping C element. Co element, La element, O element, Sr element, and F element, respectively. From the image obtained by color-mapping the F element indicated in FIG. 9(f), it was confirmed that the F element was distributed throughout the material to be doped in Example 1,

### Example 2

An anion-containing inorganic solid material was produced in the same manner as in Example 1 except that a composition represented by a metal oxide La_{0.5}Sr_{0.5}CoO₃ having a perovskite crystal structure was used as the material to be doped.

### Production Example 1

In Production Example 1, a metal oxide La_{0.5}Sr_{0.5}CoO₃ having a perovskite crystal structure was prepared, and the oxygen vacancy forming step and the laminating step were performed in the same manner as in Example 2 to form a laminate 10 including a doping target layer 1 composed of a composition represented by a composition formula La_{0.5}Sr_{0.5}CoO_{2.85}.

### Production Example 2

In Production Example 2, a metal oxide La_{0.5}Sr_{0.5}CoO₃ as a raw material having a perovskite crystal structure was prepared.

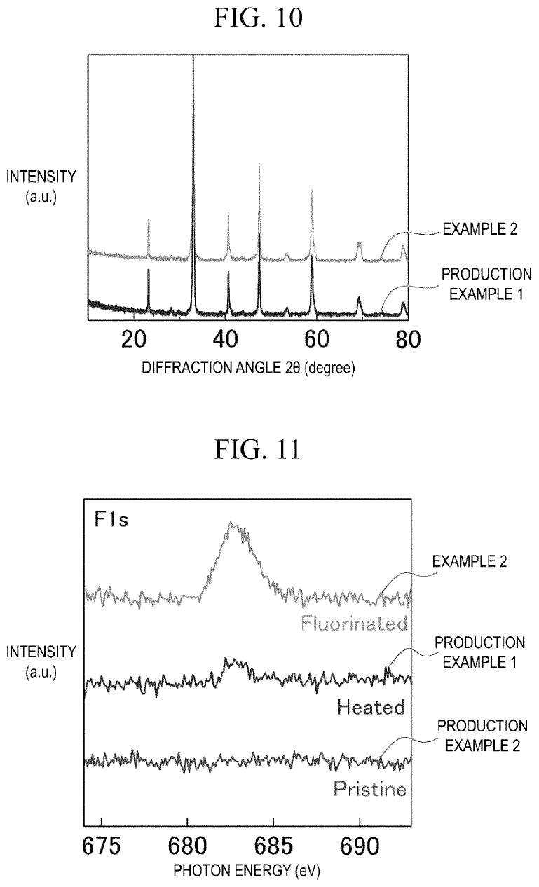

The anion-containing inorganic solid material produced in Example 2 and the composition produced in Production Example 1 were subjected to XRD measurement. For the XRD measurement, a powder X-ray diffractometer (available from Bruker, device name: D2 Phaser) was used. FIG. 10 indicates XRD measurement results of Example 2 and Production Example 1. From the XRD measurement results indicated in FIG. 10, the XRD measurement results of Example 2 and Production Example 1 had peaks at the same positions, and it was confirmed that the perovskite crystal structure was maintained even when the doping step was performed.

Next, X-ray photoelectron spectroscopy (XPS) was performed on the anion-containing inorganic solid material produced in Example 2 and the inorganic solid materials of Production Examples 1 and 2, The X-ray photoelectron spectroscopy was performed using an electron probe microanalyzer (available from JEOL Ltd., device name: JXA-8200). FIG. 11 indicates XPS measurement results of the anion-containing inorganic solid material of Example 2 and the inorganic solid materials of Production Examples 1 and 2. The anion-containing inorganic solid material prepared in Example 2 indicated a strong peak at about 682 (photon energy/eV), and it was confirmed that a larger amount of fluoride ions was introduced as compared with Production Example 1 in which the doping step was not performed and Production Example 2 which is the metal oxide as the raw material.

### Example 3

First, a metal oxide La_{0.5}Sr_{0.5}CoO₃ having a perovskite crystal structure was prepared as the material to be doped. In the oxygen vacancy forming step, the metal oxide was annealed and cooled to form an oxygen vacancy. The annealing of the metal oxide was performed by placing the metal oxide in a sealed furnace body and heating the metal oxide at 250° C. for 48 hours in an argon gas atmosphere. Then, the metal oxide was quenched at a cooling rate of 500° C./hour or more to fix an oxygen amount. By the annealing and cooling, a material to be doped represented by a composition formula La_{0.5}Sr_{0.5}CoO_{3-δ}(0<δ<3) was formed.

Next, in the mixing step, the material to be doped represented by the composition formula La_{0.5}Sr_{0.5}CoO_{3-δ}(0<δ<3) and a water-soluble solid electrolyte BaF₂ were mixed using a mortar and a pestle to form a mixture. In the mixing step, a volume ratio of the material to be doped: the solid electrolyte in the mixture was made to be 60:40.

Next, a laminate was formed in the same manner as in Example 1 except that the mixture was used to form the doping target layer, BaF₂ was used to form the solid electrolyte layer, and a voltage application condition in the doping step. Next, in the doping step, a voltage of 0.5 to 2.5 V was applied between the doping target layer and the reversible electrode, and a current flowing in a closed circuit with respect to a weight of the material to be doped La_{0.5}Sr_{0.5}CoO₃ was maintained at 2 mA/g.

In Example 3, a voltage was applied between the doping target layer and the reversible electrode in such a manner that the material to be doped in the doping target layer was doped with a fluoride ion to obtain an anion-containing inorganic solid material represented by the composition formula La_{0.5}Sr_{0.5}CoO_{3-δ}F_{0.2} (0<δ<3). In Example 3, the material to be doped was doped with a fluoride ion and then decomposed, the doping target layer was taken out from the laminate, and the doping target layer was immersed in pure water to be washed, thereby independently taking out the anion-containing inorganic solid material in which the material to be doped was doped with an anion.

### Example 4

An anion-containing inorganic solid material was produced in the same manner as in Example 3, except that in the doping step, a voltage of 0.5 to 2.5 V was applied between the doping target layer and the reversible electrode, and the current flowing in the closed circuit with respect to the weight of the material to be doped La_{0.5}Sr_{0.5}CoO₃ was maintained at 1 mAig. In Example 4, a voltage was applied between the doping target layer and the reversible electrode in such a manner that an anion-containing inorganic solid material represented by the composition formula. La_{0.5}Sr_{0.5}CoO_{3-δ}F_{0.1} (0<δ<3) was obtained.

### Production Example 3

An inorganic solid material was prepared in the same manner as in Example 3 except that the doping step was not performed.

### Production Example 4

An inorganic solid material represented by the composition formula La_{0.5}Sr_{0.5}CoO₃ used as a raw material in Examples 3 and 4 was prepared.

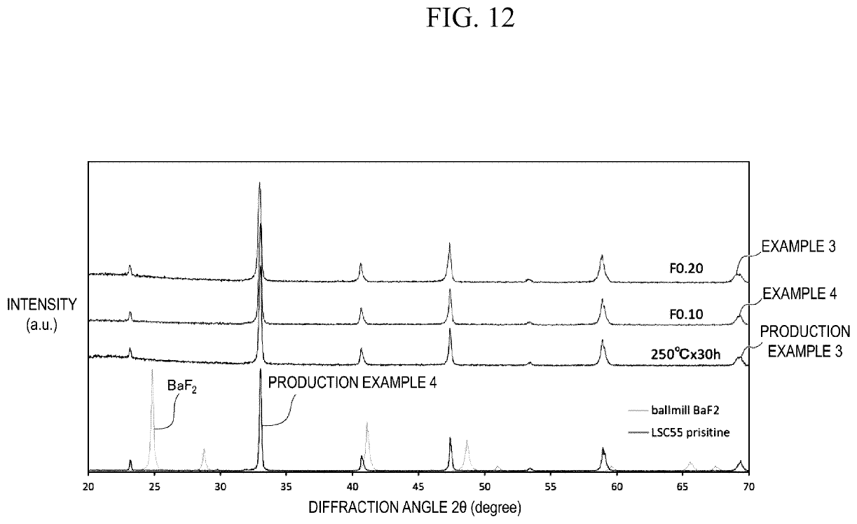

XRD measurement was performed on the anion-containing inorganic solid materials of Examples 3 and 4, the inorganic solid materials of Production Examples 3 and 4, and BaF2 used as the solid electrolyte for producing the anion-containing inorganic solid materials of Examples 3 and 4. FIG. 12 indicates XRD measurement results of the anion-containing inorganic solid materials of Examples 3 and 4, the inorganic solid materials of Production Examples 3 and 4, and the solid electrolyte BaF₂. When the XRD measurement results indicated in FIG. 12 were confirmed, a peak was confirmed at a position where a diffraction angle 2θ was about 25° from the solid electrolyte BaF₂, but a peak due to the solid electrolyte BaF₂ was not confirmed from Production Example 4 in which no water-soluble solid electrolyte was used, and Examples 3 and 4 and Production Example 3 in which the washing step was performed. Accordingly, from the

XRD measurement results indicated in FIG. 12, it was confirmed that the water-soluble solid electrolyte was removed by the washing step. The anion-containing inorganic solid materials of Examples 3 and 4 exhibited the same XRD pattern as that of the inorganic solid material having a perovskite crystal structure of Production Example 4 before treatment, and it was confirmed that the crystal structure was maintained even after doping.

The anion-containing inorganic solid materials of Examples 3 and 4 and the inorganic solid materials of Production Examples 3 and 4 were analyzed using an electron probe microanalyzer (EPMA). Table 1 indicates EPMA measurement results of the anion-containing inorganic solid materials of Examples 3 and 4 and the inorganic solid materials of Production Examples 3 and 4.

TABLE 1

| | La | Sr | Co | O | F |
|---|---|---|---|---|---|
| Example 3 | 0.45 ± 0.09 | 0.58 ± 0.1 | 1 ± 0.13 | 3.88 ± 0.32 | 0.24 ± 0.08 |
| Example 4 | 0.34 ± 0.2 | 0.53 ± 0.14 | 1 ± 0.15 | 3.74 ± 0.22 | 0.01 ± 0.03 |
| Comparative Example 3 | 0.50 ± 0.11 | 0.57 ± 0.11 | 1 ± 0.08 | 2.89 ± 0.2 | 0 |
| Comparative Example 4 | 0.44 ± 0.09 | 0.62 ± 0.11 | 1 ± 0.08 | 3.29 ± 0.18 | 0 |

From the EPMA measurement results indicated in Table 1, it was confirmed that in Example 3 in which a larger current was flowed through the closed circuit, a larger amount of fluoride ions as compared with Example 4 in which a smaller current was flowed through the closed circuit. Furthermore, when an error of Example 3 in which a large current was flowed between the doping target layer and the reversible electrode is compared with an error of Example 4 in which a small current was flowed between the doping target layer and the reversible electrode, the error of Example 4 is larger. It is presumed that at an initial stage of starting to flow the current, a fluoride ion is taken into not a site of oxygen vacancy but a vacancy of the parent phase, and when the fluoride ion is taken into the vacancy of the parent phase, the site of oxygen vacancy is doped with a fluoride ion.

### Example 5

First, as a material to be doped, an inorganic solid material La_{1.2}Sr_{0.8}MnO₄ having a crystal structure of a layered perovskite structure was prepared. In the inorganic solid material, a part of sites is in a vacant state.

Next, a powder of the inorganic solid material and a powder of the water-soluble solid electrolyte Ba_{0.99}K_{0.01}F_{1.99} were mixed in the same manner as in Example 3 to prepare a mixture.

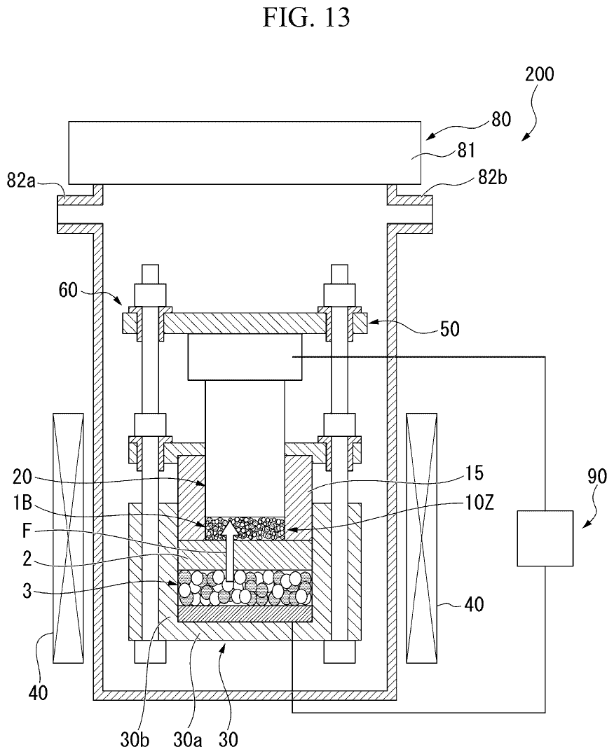

Next, a production apparatus 200 as illustrated in FIG. 13 was used, and the laminating step was performed to produce a laminate 10B. In the laminating step, about 0.5 g of a PbF₂-Pb powder was contained in a SUS-made housing portion 30 having an opening at one end. Then, the PbF₂-Pb powder was pressed at 60 MPa by the pressing portion 20 haying a shape corresponding to the housing portion 30 to form the reversible electrode 3 having a diameter of 14.5 mm and a thickness of 0.5 mm. Then, a powder of water-soluble solid electrolyte Ba_{0.99}K_{0.01}F_{1.99} was placed on the reversible electrode 3 and pressed at 60 MPa by the pressing portion 20 to form the solid electrolyte layer 2 having a diameter of 14.5 mm and a thickness of 0.5 mm. A ring of polytetrafluoroethylene (PTFE), which was an insulating material, was disposed as the protective portion 15 on the solid electrolyte layer 2, and the mixture was placed inside the protective portion 15 and pressed at a 130 MPa using the pressing portion 20 to form a doping target layer 1B having a diameter of 10 ram and a thickness of 1 mm. As described above, in the laminating step, the laminate 10B in which the reversible electrode 3, the solid electrolyte layer 2, and the doping target layer 1B were laminated in this order was formed.

Next, the SUS-made pressing portion 20 having the same shape in a plan view as the doping target layer 1B and serving as a conductive member capable of pressing the laminate 10B in the laminating direction was disposed on the laminate 10B, and a voltage was applied in such a manner that the potential of the pressing portion 20 was higher than the potential of the housing portion 30 in a state where the laminate 10B was pressed and fixed in the laminating direction to perform the doping step. In the doping step, the laminate was controlled at 250° C. by the heating unit 40 under an Ar gas atmosphere in which the gas in the sealed vessel 80 was exhausted through the gas exhaust portion 82b and a gas was introduced into the sealed vessel 80 through the gas introduction portion 82a. In addition, in the doping step, a voltage of 2 to 7 V was applied between the doping target layer 1B and the reversible electrode 3 by the voltage applying unit 90, and the current flowing through the closed circuit was maintained at 2 mA/g.

### Example 6

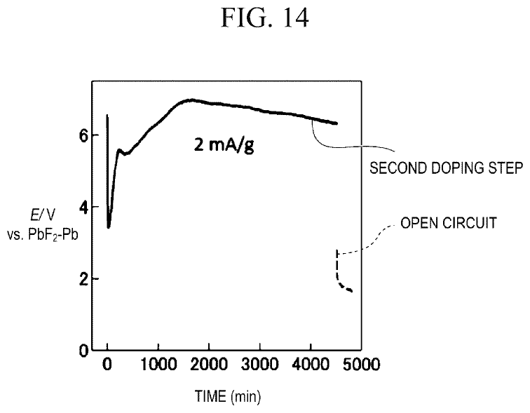

After the material to be doped was doped with a fluoride ion in the same manner as in Example 5, a laminate was formed again in the second laminating step, and anion doping was performed again in the second doping step to prepare an anion-containing inorganic solid material. FIG. 14 indicates a change with time of a voltage value applied between the doping target layer 1B and the reversible electrode 3 in the second doping step. The solid line in the figure indicates time dependence of the voltage value applied to the laminate in the doping step of Example 6. The dashed line in the figure indicates current-voltage response at an open circuit after the doping step of Example 6.

In the second laminating step in Example 6, the laminate used in Example 5 was removed, and about 0.5 g of a PbF₂-Pb powder was placed in the housing portion 30 and pressed at 60 MPa by the pressing portion 20 to form a reversible electrode. Next, the solid electrolyte Ba_{0.99}K_{0.01}F_{1.99} was placed on the reversible electrode and pressed at 60 MPa by the pressing portion 20 to form a solid electrolyte layer. Next, the composite cell doped with an anion in Example 5 was placed on the solid electrolyte layer to form a second laminate.

Next, an SUS member having the same planar shape as that of the composite cell was disposed, and the second doping step was performed. In the second doping step, the laminate was in a heating environment of 250° C. under an Ar gas atmosphere, and a current was flowed through the closed circuit for 38 hours in such a manner that the potential of the doping target layer was 2 to 12 V higher than the potential of the reversible electrode, and the current value with respect to the weight of the material to be doped was 1 mA/g.

### Example 7

An anion-containing inorganic solid material was prepared in the same manner as in Example 6 except that after the second doping step, the washing step was perfbrrned in the same manner as in Example 3.

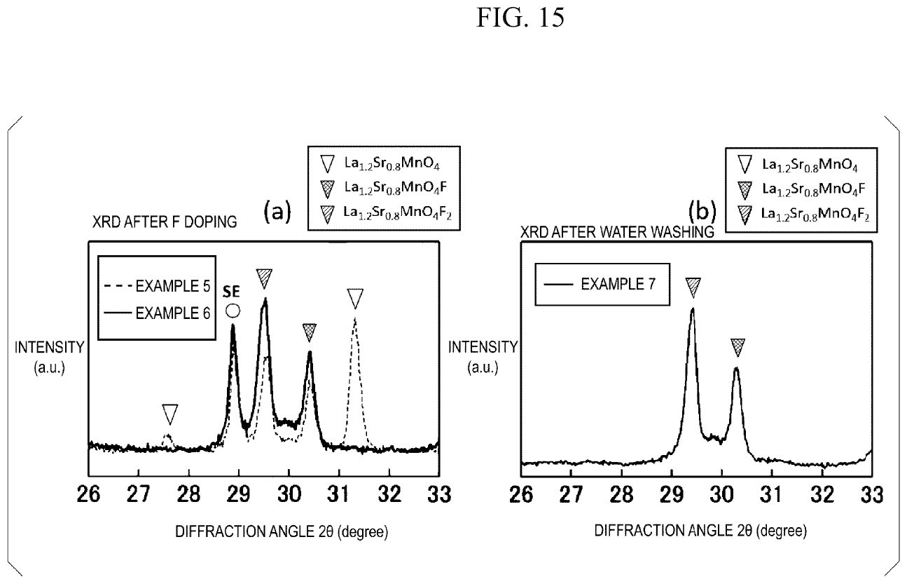

The anion-containing inorganic solid materials of Examples 5, 6, and 7 were subjected to XRD measurement. FIGS. 15(a) and 15(b) indicate XRD measurement results of the anion-containing inorganic solid materials of Examples 5 and 6 and a XRD measurement result of the anion-containing inorganic solid material of Example 7, respectively. From the results of FIG. 15(a), it was confirmed that the anion-containing inorganic solid materials of Examples 5 and 6 were doped with fluoride ions. In addition, when patterns of the solid line and the broken line in FIG. 15(a) are compared with each other, in an example in which the time for which F element doping is performed is short as in Example 5, a phase of La_{1.2}Sr_{0.8}MnO₄ before F element doping remained. On the other hand, in a case where anion doping is sufficiently performed as in Example 6, the phase of La_{1.2}Sr_{0.8}MnO₄ before element doping scarcely remained, and a phase of La_{1.2}Sr_{0.8}MnO₄F and a phase of La_{1.2}Sr_{0.8}MnO₄F₂ each had a high intensity. Thus, in Example 6, it was confirmed that the phase of La_{1.2}Sr_{0.8}MnO₄ was further doped with a fluoride ion. Furthermore, when the XRT) measurement results of FIGS. 15(a) and 15(b) were compared, it was confirmed that the water-soluble solid electrolyte La_{1.2}Sr_{0.8}MnO₄ was removed by the washing step. In addition, it was confirmed that La_{1.2}Sr_{0.8}MnO₄F, La_{1.2}Sr_{0.8}MnO₄F₂ doped with a fluoride ion remained in the water-soluble solid electrolyte even after the washing step.

### Example 8

An anion-containing inorganic solid material was produced in the same manner as in Example 1 except that LiNi_{1/3}Co_{1/3}Mo_{1/3}O₂ having a layered rock-salt crystal structure was used as the material to be doped, La_{0.9}Ba_{0.1}F_{2.9} was used as the solid electrolyte layer, and. LiNi_{1/3}Co_{1/3}Mo_{1/3}O₂ was heated at 600° C., for 72 hours in the oxygen vacancy forming step.

Note that in Example 8, to convert the material to be doped into LiNi_{1/3}Co_{1/3}Mo_{1/3}O_{1.97}, in the oxygen vacancy forming step, the inorganic solid material LiNi_{1/3}Co_{1/3}Mo_{1/3}O₂ was housed in a sealed furnace body and heated at 600° C. for 72 hours in an argon gas atmosphere. After heating, the metal oxide was cooled to room temperature while being housed in the furnace body.

### Example 9

An anion-containing inorganic solid material was produced in the same manner as in Example 8 except that La_{0.9}Ca_{0.1}O_{0.9}Cl was used as the solid electrolyte and a Pb-PhCl₂ mixture was used as the reversible electrode.

### Production Example 5

As Production Example 5, a metal oxide LiNi_{1/3}Co_{1/3}Mo_{1/3}O₂ as a raw material having a layered rock-salt crystal structure used in Examples 8 and 9 was prepared.

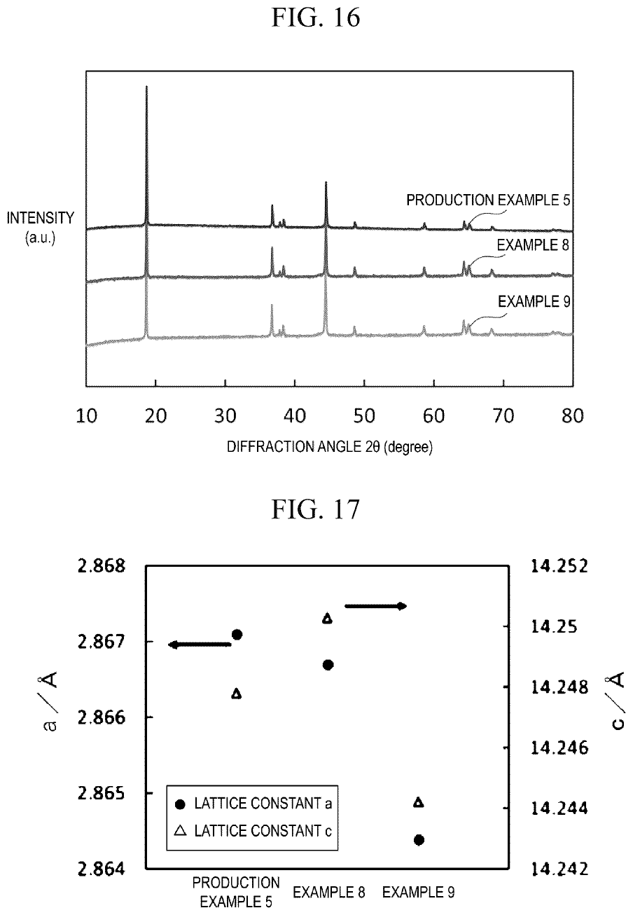

In Example 8, the anion-containing inorganic solid material LiNi_{1/3}Co_{1/3}Mo_{1/3}O₂F_{0.019} was obtained. In Example 9, the anion-containing inorganic solid material LiNi_{1/3}Co_{1/3}Mo_{1/3}O₂Cl_{0.02} was obtained. The anion-containing inorganic solid materials of Examples 8 and 9 and the inorganic solid material of Production Example 5 were subjected to XRD measurement in the same manner as in Example 2. FIG. 16 indicates XRD measurement results of Examples 8 and 9 and Production Example 5. When the ACRD measurement results of Examples 8 and 9 were compared with the XRD measurement result of Production Example 5, a peak corresponding to an impurity phase was not detected in the XRD patterns of Examples 8 and 9, and it was confirmed that the crystal structure was not changed but maintained even when fluoride ion doping was performed as in Example 8 or chloride ion doping was performed as in Example 9.

FIG. 17 is a diagram indicating lattice constants estimated from the X-ray diffraction pattern of Example 8, From FIG. 17, it was confirmed that a lattice constant a was decreased and a lattice constant c was increased by fluoride ion doping, the lattice constants a and c were decreased by chloride ion doping, and in any case, the crystal lattice was changed.

### Example 10

An anion-containing inorganic solid material was produced in the same manner as in Example 3 except that LiMnO₄ haying a spinel crystal structure was used as the material to be doped, conditions of an oxygen vacancy forming step were changed to the following conditions, and the value of the current flowing through the closed circuit in the doping step was maintained at 2 mAk/g.

In Example 10, in the oxygen vacancy forming step, an oxygen vacancy was formed in the material to be doped to change the composition of the inorganic solid material to LiMnO_{3.7}. In the oxygen vacancy forming step, the material to be doped was heated at 700° C. in an argon gas atmosphere containing 1% of O₂ by using the same furnace body as in Example 2. Thereafter, the inorganic solid material was cooled to room temperature while being housed in the furnace body. Thereafter, in the mixing step, the material to he doped cooled to room temperature was mixed with a water-soluble solid electrolyte BaF₂ to form a mixture,

In Example 10, in the laminating step, a reversible electrode and a solid electrolyte layer were formed by the same method as in Example 2, and then a composite cell composed of a material to be doped and a water-soluble solid electrolyte was formed as a doping target layer. In Example 9, in the doping step, the current flowing through the closed circuit was maintained at 2 mnA/g in such a manner that an anion-containing inorganic solid material represented by the composition formula LiMn₂O_{4-d}F_{0.5} (0<δ<4) was obtained,

### Production Example 6

As Production Example 6, an inorganic solid material LiMn04 as a raw material having a spinel crystal structure used in Example 10 was prepared,

### Production Example 7

In Production Example 7, the inorganic solid material prepared in Production Example 6 was subjected to the oxygen vacancy forming step, the mixing step, and the laminating step in the same manner as in Example 10 to form a laminate having a doping target layer containing a material to be doped represented by the composition formula LiMnO_{3.7}.

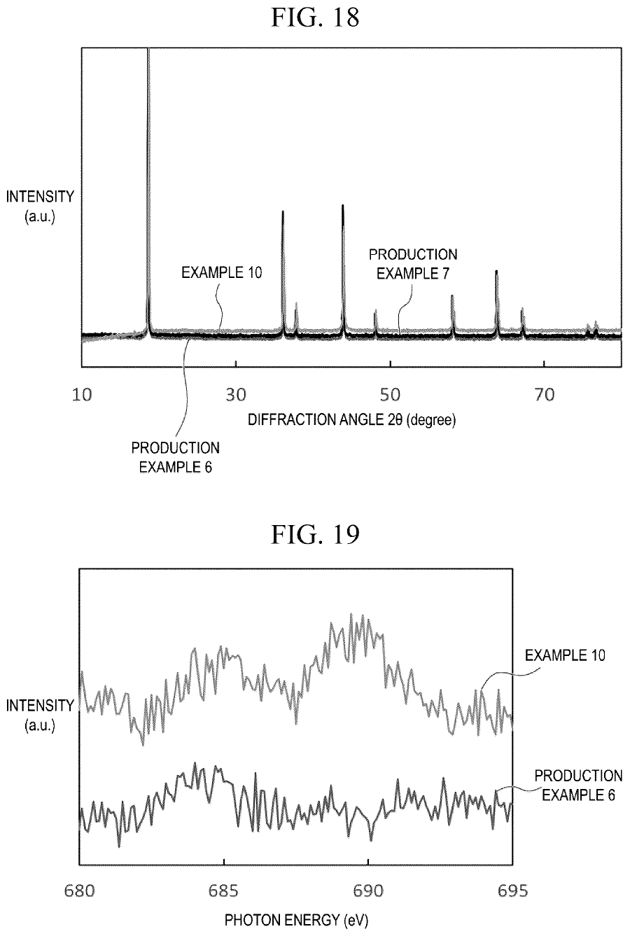

The anion-containing inorganic solid material after the washing step in Example 10 and, the inorganic solid materials in Production Examples 6 and 7 were subjected to XRD measurement in the same manner as in Example 2. FIG. 18 indicates XRD measurement results of Example 10 and Production Examples 6 and 7. When the XRD measurement results of Production Examples 6 and 7 were compared with the XRD measurement result of Example 10, a peak corresponding to an impurity phase was not detected, and similar XRD patterns were obtained. Thus, it was confirmed that the crystal lattice of the anion-containing inorganic solid material of Example 10 was deformed while maintaining symmetry of the spinel crystal structure.

The anion-containing inorganic solid material of Example 10 was subjected to composition analysis by XPS. FIG. 19 indicates XPS measurement results of the anion-containing inorganic solid material of Example 10 and the inorganic solid material of Production Example 6, The anion-containing inorganic solid material prepared in Example 10 indicated a strong peak at about 689 (photon energy/eV), and it was confirmed that a larger amount of fluoride ions was introduced as compared with Production Example 6 which was the metal oxide of the raw material.

### Example 11

In Example 11, the production apparatus 200B was reproduced and used. In the production apparatus 200B reproduced in Example 11, the pressing device 60 and the sealed, vessel 80 having the same configurations as those in Example 1 were used.

First, as the laminating step, 0.5 g of a mixed powder of lead and lead fluoride in which a volumetric percentage ratio of lead fluoride was 30% was placed on the bottom wall portion 30a of the housing portion 30. The mixed powder was pressed at 60 Pa by a pressing portion 20 to form the reversible electrode 3 having a diameter of 13 mm and a thickness of 1 mm.

Then, about 0.2 g of La_{0.9}Ba_{0.1}F_{2.9} powder was prepared as a solid electrolyte, and was filled in the housing portion on the reversible electrode 3. Next, a uniaxial pressing machine (TB-100H, Sansho Industry Co., Ltd.) was used to press the powder at about 100 MPa in the laminating direction to form a solid electrolyte layer 2 of a green compact. Here, a ratio of F element in the solid electrolyte layer 2 to the material to be doped, which was to be added in a subsequent step, was set to 10 mol %.

Next, an insulating ring was disposed as the protective portion 15 on the solid electrolyte layer 2. As the ring, a tubular member having an inside diameter of 10 mm and an axial length of 20 mm was used. Next, two or three sheets of mesh made of Pt (80 mesh, available from Tanaka. Kikinzoku Kogyo K.K.) were stacked on the radially inner side of the ring to form a metal mesh 5. A size of the metal mesh 5 in the in-plane direction was substantially equal to the inner diameter of the protective portion 15. A Pt mesh used as the metal mesh 5 had an opening of about 250 μm. Next, a pellet cell composed of an inorganic oxide LiMn₂O₄ having a spinel crystal structure was formed on the metal mesh 5 as a doping target layer having a diameter of 10 mm and a thickness of 1 mm, By the above procedure, the laminate 10Y in which the reversible electrode 3, the solid electrolyte layer 2, the metal mesh 5, and the doping target layer 1 were laminated in this order was formed.

Next, as a potential adjusting step, a conductive wire was formed in such a manner that the potential of the metal mesh 5 was equal to the potential of the surface of the doping target layer 1 opposite to the surface in contact with the metal mesh 5. That is, the conductive wire was formed in such a manner that the metal mesh 5 and an end surface of the pressing portion 20 on the metal mesh 5 side were connected to each other.

Next, the pressing portion 20 as a conductive member was disposed on the laminate 10Y, and the laminate 10 and the metal plate 4 as a lead substrate were pressed and fixed by a bolt and a nut in a state of being housed in the housing portion 30 of the pressing device 60. In this state, one end of the sealed vessel 80 was closed with the cover 81, a gas in the sealed vessel 80 was discharged through the gas discharge portion 82, and the sealed vessel 80 was filled with argon gas through the gas introduction portion 82a. Next, the voltage applying unit 90 applied a voltage between the pressing portion 20 and the housing portion 30 in such a manner that a potential of the pressing portion 20 to be higher than that of the housing portion 30, thereby performing the doping step. In the doping step, the sealed vessel 80 was pressurized to about 1×10⁴ Pa, the laminate 10Y was heated to 250° C. by the heating unit 40, and the voltage between the reversible electrode 3 and the doping target layer 1 was controlled. The voltage application was controlled in such a manner that the value of the current flowing through the conductive wire CW with respect to the weight (g) of the material to be doped in the laminate 10Y was, for example. 1 mA/g. The voltage application was performed at a constant current for 18 hours.

### Example 12

A sample was produced in the same manner as in Example 11 except that in the laminating step, the amount of the solid electrolyte was adjusted and the voltage application time was changed to 36 hours. To be more specific, about 0.2 g of La_{0.9}Ba_{0.1}F_{2.9} powder was prepared as the solid electrolyte, and was filled in the housing portion on the reversible electrode 3. Next, a uniaxial pressing machine (TB-100H, Sansho Industry Co., Ltd.) was used to press the powder at 100 MPa in the laminating direction to form a solid electrolyte layer 2 of a green compact. Here, the ratio of F element in the solid electrolyte layer 2 to the material to be doped, which was to be added in a subsequent step, was set to 20 mol %.

### Analysis

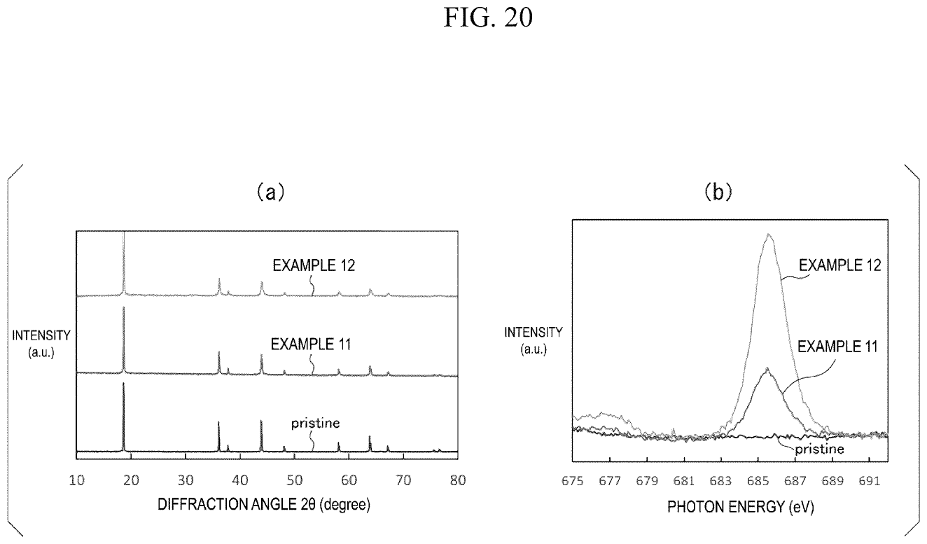

XRD measurement and XPS were performed on the samples of Examples 11 and 12 and the materials to be doped used in Examples 11 and 12 before treatment in the same manner as in Example 2. FIG. 20(a) indicates XRD measurement results of Example 11, Example 12, and the powder of the material to be doped before the doping step. From FIG. 20(a), it was confirmed that in Example 11 and Example 12, there was a peak at the same position as that of the material to be doped before the doping step, and the spinel crystal structure was maintained even when the doping step was performed.

FIG. 20(b) indicates XPS measurement results of Example 11, Example 12, and the material to be doped before the doping step. From the XPS measurement results indicated in FIG. 20(b), in Example 11 and Example 12, a peak was confirmed at a photon energy of about 68.5 eV, and thus, it was confirmed that fluoride ion doping was performed in the doping step. In addition, the measurement conditions were the same in Example 11 and Example 12 and the peak intensity at the photon energy of about 685 eV was higher in Example 12 than in Example 11. Thus, it was confirmed that the fluoride ion doping was performed at a higher concentration in Example 12 than in Example 11.

In addition, the samples of Examples 11 and 12 and the materials to be doped used in Examples 11 and 12 before treatment were analyzed by time-of-flight secondary ion mass spectrometry (TOF-SIMS). The TOF-SIMS analysis was performed with a time-of-flight secondary ion mass spectrometer (available from IONTOF GmbH, Model No.: TOF-S1MS5-100) under the following conditions.
Primary ion: Bi₃⁺⁺
Sputter ion: Cs⁺
Acceleration voltage: 25 kV (primary ion), 1 kV (sputter ion)
Ion current: 0.02 pA (primary ion), 80 nA (sputter ion)
Sputtering time: 1000 to 1500 seconds/cycle

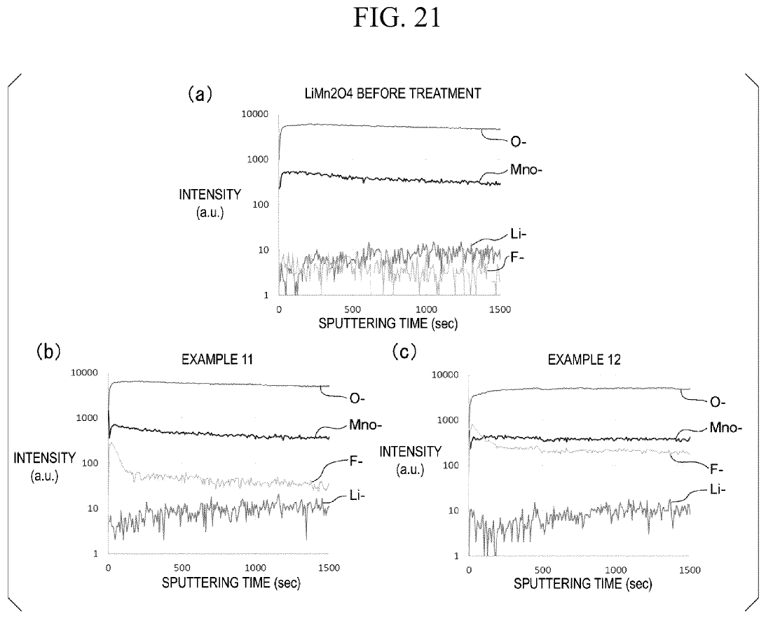

FIGS. 21(a), 21(b), and 21 (c) indicate TOF-SIMS spectra of the materials to be doped before treatment, and the samples of Example 11 and Example 12, respectively. In the TOF-SIMS spectra, the horizontal axis represents the cumulative sputtering time in the TOF-SIMS analysis. In the TOF-SIMS spectra, a large value on the horizontal axis indicates that a composition at a position distant from the surface of the sample is analyzed, and a small value on the horizontal axis indicates that a composition at a position close to the surface of the sample is analyzed. In addition, a larger value on the vertical axis indicates that an element is contained at a higher concentration in the analyzed portion of the sample. From the TOF-SIMS spectra indicated in FIGS. 21(b) and 21(c), it was confirmed that, in Examples 11 and 12, elemental fluorine was contained in the sample at a particularly high concentration in the vicinity of the sample surface, and elemental fluorine was uniformly contained at a position distant from the sample surface. Furthermore, it was confirmed that elemental fluorine was contained at a higher concentration in Example 12 than in Example 11.

### Example 13

A sample was prepared in the same manner as in Example 12 except that the materials constituting the laminate were partially changed. In Example 13, Ba_{0.99}K_{0.01}Cl_{1.99} was used as the solid electrolyte powder of the solid electrolyte layer 2, the reversible electrode 3 was composed of PbCl₂-Fb, and the material to be doped LiMn₂O₄ was doped with a fluoride ion. An amount of the solid electrolyte powder in the solid electrolyte layer 2 was adjusted in such a manner that the ratio of Cl element in the solid electrolyte layer 2 to the material to be doped, which was to be added in a subsequent step, was 20 mol %.

### Analysis

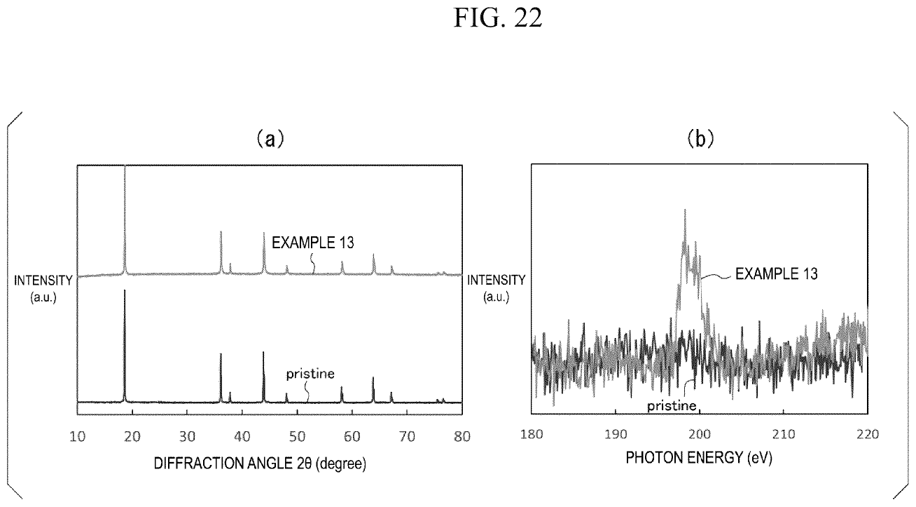

XRD measurement and XPS were performed on the sample of Example 13 and the material to be doped used in Example 13 before treatment in the same manner as in Example 2. FIG. 22(a) indicates XRD measurement results of the sample of Example 13 and the material powder to be doped before the doping step. From FIG. 22(a), in Example 13, there was a peak at the same position as that of the material to be doped before the doping step, and it was confirmed that even when the doping step was performed, the spinel crystal structure was maintained and impurities were not particularly formed.

FIG. 22(b) indicates XPS measurement results of the sample of Example 13 and the material to be doped before the doping step. From the XPS measurement results indicated in FIG. 22(b), in Example 13, a peak was confirmed at a photon energy of about 200 eV, and thus it was confirmed that fluoride ion doping was performed in the doping step.

### Example 14

By the same procedure as in Example 11 except that the materials constituting the laminate were partially changed and the conditions of the doping step were changed, oxide ions were partially substituted with fluoride ions while maintaining the crystal of the material to be doped. In Example 14, the doping target layer 1 composed of the material to be doped Li₂NiO₃ having a layered rock-salt crystal structure was used. In Example 14, an amount of the solid electrolyte powder in the solid electrolyte layer 2 was adjusted in such a manner that a ratio of Cl element in the solid electrolyte layer 2 with respect to the material to be doped, which was to be added in a subsequent step, was 120 mol %. In Example 14, in the doping step, a voltage of 3.0 to 5.0 V was applied between the doping target layer 1 and the reversible electrode 3, and a current flowing through the closed circuit with respect to the weight of the material to be doped Li₂NiO₃ was maintained at 5 mA/g.

### Analysis

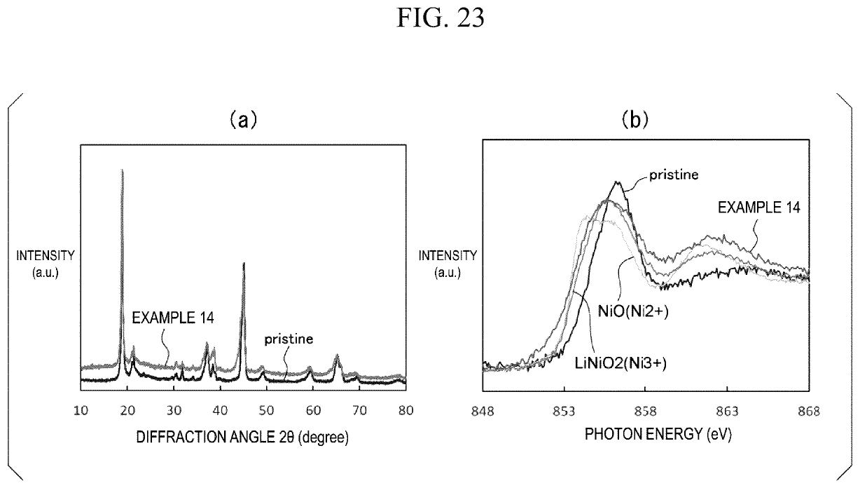

XRD measurement was performed on the sample of Example 14 and the material to be doped before treatment used in Example 14 in the same manner as in Example 2. FIG. 23(a) indicates XRD measurement results of Example 14 and the material powder to be doped before the doping step. From FIG. 23(a), in Example 14, there was a peak at the same position as that of the material to be doped before the doping step, and it was confirmed that even when the doping step was performed, the layered rock-salt crystal structure was maintained and impurities were not particularly formed.

XPS was performed in the same manner as in Example 2 on the sample of Example 14 and the material to be doped before treatment used in Example 14, as well as nickel (II) oxide and lithium nickel (III) dioxide for reference. It is known that the lower the valence of nickel, the more the peak near the photon energy of 857 eV shifts to the left. FIG. 23(b) indicates XPS measurement results of the sample of Example 14, the material to be doped before the doping step, nickel (II) oxide, and lithium nickel (III) dioxide. From the XPS measurement results indicated in FIG. 23(b), in Example 14, a peak was confirmed at a photon energy of about 857 eV, and thus it was confirmed that fluoride ion doping was performed in the doping step. In addition, the photon energy at this peak was substantially the same as the photon energy at the peak of lithium nickel (III) dioxide, and thus it is considered that the valence of Ni in the anion-containing inorganic solid material obtained in Example 14 was about 3 and the material to be doped was a composition represented by Li₂NiO₂Fₓ.

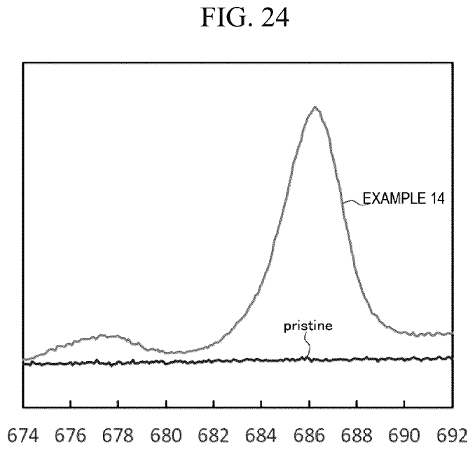

TOF-SIMS analysis was performed on the sample of Example 14 and the material to be doped before treatment used in Example 14 in the same manner as in Example 2. FIG. 24 indicates TOF-SIMS spectra of the sample of Example 14 and the material to be doped before treatment used in Example 14. From the peak intensity of the TOF-SIMS spectra confirmed in FIG. 24, it was found that when the composition formula of the obtained anion-containing inorganic solid material was represented by Li₂NiO_{3-δ}Fₓ, x=0.8±0.4 was satisfied. x is a numerical value determined in consideration of the peak intensity in the TOF-SIMS spectra, the weight of the material to be doped, the current, and the time. δ can be estimated from the highest peak intensity of the Ni element from the above x and the XPS measurement results indicated in FIG. 23(b), but is estimated from the TOE-SIMS spectra in the same manner as x to evaluate an internal composition. That is, in Example 14, it was confirmed that the layered rock-salt crystal structure of the material to be doped was maintained and much of elemental oxygen contained in the material to be doped was substituted with elemental fluorine.

### Preparation of Battery Cell

A Li ion battery cell using the anion-containing inorganic solid material prepared in Example 14 (referred to as Example 15) and a Li ion battery cell using Li₂NiO₂F having a disordered rock-salt crystal structure (referred to as Comparative Example 1) were prepared. In Example 15 and Comparative Example 1, configurations of the battery cell other than a. configuration of an electrode layer for a positive electrode were the same.

### Electrode Layer

As the electrode layer for the positive electrode of Example 15, Li₂NiO_{3-δ}Fₓ, which was the anion-containing inorganic solid material having a layered rock-salt structure prepared in Example 14, acetylene black, and polyvinylidene fluoride (PVDF) were mixed at a weight ratio of 70:20:10, applied onto an Al current collector, and vacuum-dried at 80° C. Furthermore, a Li metal plate was prepared as a negative electrode.

The electrode layer for the positive electrode of Comparative Example 1 was prepared by mixing Li₂NiO₂F having a disordered rock-salt structure, acetylene black, and polyvinylidene fluoride (PVDF) at a weight ratio of 70:20:10, applying the mixture on an Al current collector, and vacuum-drying the mixture at 80° C.

Electrolyte liquid

1 mol/L of LiPF₆ EC: DMC (EC DMC=1:1) was prepared.

### Separator

Celgard #2500 was prepared.

### Characteristic Evaluation of Battery Cell

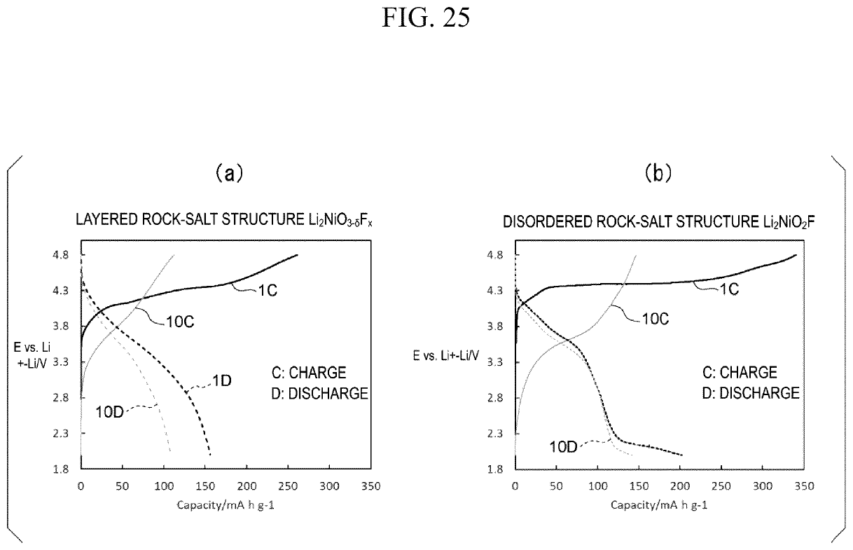

Each of the battery cells of Example 15 and Comparative Example 1 was subjected to a constant current charge/discharge test ten times in a thermostat at 25° C. using a charge/discharge device (available from MEIDEN HOKUTO CORPORATION, model number: HJ1001SD8). The charge/discharge current was set to 10 mA/g. FIG. 25(a) indicates a charge/discharge curve of the battery cell of Example 15, and FIG. 25(b) indicates a charge/discharge curve of the battery cell of Comparative Example 1.

It was confirmed that the battery cell obtained in Example 15 was superior in battery capacity and cycle characteristics to the battery cell obtained in Comparative Example 1. The difference in characteristics between the battery cells is considered to be due to the fact that the anion-containing inorganic solid material used in the positive electrode layer in Example 15 maintains a layered rock-salt structure, and can smoothly diffuse in the layer where elemental Li is located without being inhibited by a transition metal element.

### INDUSTRIAL APPLICABILITY

Introduction of one or more anion species into an inorganic solid material in an arbitrary amount has high industrial applicability from the viewpoint of utilizing the functionality of the anions. In addition, in contrast to the disordered rock-salt structure in which Li element and transition metal element are irregularly arranged and a path through which lithium ions can diffuse is not determined, in the layered rock-salt structure represented by the general Formula (1), the Li element and the transition metal element are layered and lithium ions can smoothly diffuse in the layer, and thus the layered rock-salt structure has high industrial applicability from the viewpoint of improving the cycle characteristics. In particular, an anion-containing inorganic solid material containing an anion at a high concentration has high industrial applicability from the viewpoint that it becomes possible to control redox species during charge and discharge.

### REFERENCE SIGNS LIST

1A, 1B: doping target layer, 2: solid electrolyte layer, 3: reversible electrode, 10A, 1B: laminate, 15: protective portion, 20: pressing portion, 30: housing portion, 30a: bottom wall portion, 30b: sidewall portion, 40: heating unit, 80: sealed vessel, 90: voltage applying unit

1. A method for producing an anion-containing inorganic solid material, the method comprising:
a laminating step of forming a laminate comprising an electrode, a solid electrolyte layer, and a doping target layer containing a material to be doped; and
a doping step of doping the material to be doped with an anion using the doping target layer as a reaction field by applying a voltage to the laminate to have a potential of the doping target layer to be higher than a potential of the electrode.

2. The method for producing an anion-containing inorganic solid material according to claim 1, wherein in the laminating step, the electrode, the solid electrolyte layer, and the doping target layer are laminated in this order to be in contact with each other as the laminate.

3. The method for producing an anion-containing inorganic solid material according to claim 1, wherein in the laminating step, the electrode, the solid electrolyte layer, a metal mesh, and the doping target layer are laminated in this order to be in contact with each other as the laminate,
the method further comprises a potential adjusting step, and
in the potential adjusting step, a conductive wire is provided to have a potential of the metal mesh to be equal to a potential of a surface of the doping target layer, the surface being opposite to a surface of the doping target layer that is in contact with the metal mesh.

4. The method for producing an anion-containing inorganic solid material according to claim 1, further comprising, before the laminating step, an oxygen vacancy forming step of forming an oxygen vacancy in the material to be doped by heating and cooling an inorganic oxide to be used as the material to be doped under an inert gas atmosphere,
wherein in the doping step, the oxygen vacancy of the material to be doped is doped with the anion.

5. The method for producing an anion-containing inorganic solid material according to claim 1, wherein in the laminating step, the laminate is formed by using a halide as the solid electrolyte layer, and
in the doping step, a halide ion is used as the anion for doping.

6. The method for producing an anion-containing inorganic solid material according to claim 5, wherein in the laminating step, the laminate is formed by using, as the solid electrolyte layer and the electrode, a solid electrolyte layer comprising a halide and a reversible electrode comprising a halide, respectively, and
in the doping step, the material to be doped is doped with a halide ion in the reversible electrode through the solid electrolyte layer.

7. The method for producing an anion-containing inorganic solid material according to claim 1, wherein in the laminating step, the doping target layer is formed with a mixture obtained by mixing the material to be doped and a soluble solid electrolyte.

8. The method for producing an anion-containing inorganic solid material according to claim 7, further comprising a washing step of washing the mixture to remove the soluble solid electrolyte after the doping step.

9. The method for producing an anion-containing inorganic solid material according to claim 1, wherein the material to be doped is a metal oxide having any of a crystal structure selected from a perovskite structure, a layered perovskite structure, a layered rock-salt structure, and a spinel structure.

10. The method for producing an anion-containing inorganic solid material according to claim 1, wherein before the laminating step, an oxygen vacancy forming step of forming an oxygen vacancy in the material to be doped is not performed,
in the laminating step, the laminate is formed by using, as the material to be doped, a metal oxide having a layered perovskite structure, and
after the laminating step, the doping step is performed.

11. The method for producing an anion-containing inorganic solid material according to claim 1, the method comprising:
a first laminating step of forming a first laminate, the first laminate comprising a first reversible electrode, a first solid electrolyte layer, and a doping target layer containing the material to be doped, each laminated in this order;
a first doping step of doping the material to be doped with a first anion by applying a voltage to the first laminate to have a potential of the doping target layer to be higher than a potential of the first reversible electrode;
a second laminating step of forming a second laminate, the second laminate comprising a second reversible electrode, a second solid electrolyte layer, and a doping target layer containing a material to be doped that has been doped with the first anion, each laminated in this order; and
a second doping step of doping the material to be doped with a second anion by applying a voltage to the second laminate to have a potential of the doping target layer to be higher than a potential of the second reversible electrode.

12. The method for producing an anion-containing inorganic solid material according to claim 11, wherein
in the first laminating step, the laminate is formed by using the first solid electrolyte layer and the first reversible electrode each containing a first halide,
in the first doping step, the material to be doped is doped with a first halide ion in the first reversible electrode through the first solid electrolyte layer,
in the second laminating step, the second laminate is formed by using the second solid electrolyte layer and the second reversible electrode each containing a second halide, and
in the second doping step, the material to be doped is doped with a second halide ion in the second reversible electrode through the second solid electrolyte layer.

13. The method for producing an anion-containing inorganic solid material according to claim 1, wherein in the doping step, a potential difference is imparted between the doping target layer and the electrode while pressurizing the laminate.

14. An apparatus for producing an anion-containing inorganic solid material, the apparatus comprising:
a housing portion comprising a bottom wall portion and a sidewall portion, the housing portion being conductive and configured to house a laminate comprising an electrode, a solid electrolyte layer, and a doping target layer containing a material to be doped;
a conductive member disposed to face the bottom wall portion of the housing portion, the conductive member configured to press the laminate in a laminating direction of the laminate; and
a voltage applying unit configured to apply a voltage between the conductive member and the housing portion to have a potential of the conductive member to be higher than a potential of the housing portion.

15. The apparatus for producing an anion-containing inorganic solid material according to claim 14, wherein in the laminate, the electrode, the solid electrolyte layer, and the material to be doped are laminated in this order to be in contact with each other.

16. The apparatus for producing an anion-containing inorganic solid material according to claim 14, wherein in the laminate, the electrode, the solid electrolyte layer, a metal mesh, and the doping target layer are laminated in this order to be in contact with each other, and
the apparatus further comprises a conductive wire configured to connect the metal mesh and a member that is in contact with a surface of the doping target layer opposite to a surface of the doping target layer that is in contact with the metal mesh.

17. The apparatus for producing an anion-containing inorganic solid material according to claim 14, further comprising:
a sealed vessel accommodating the housing portion and the conductive member; and
a heating unit configured to heat an inside of the sealed vessel.

18. An anion-containing inorganic solid material represented by the following Formula (1) and having a layered rock-salt structure:
Li₂TMO_{3-δ}Fₓ (1)
where in Formula (1), TM is Ni or Mn, δ satisfies 0.3≤δ≤2, and x is a number satisfying 0.3≤x≤2.
